(19) United States
(12) Patent Application Publication
(10) Pub. No.: US 2023/0286580 A1
(43) Pub. Date: Sep. 14, 2023

(54) RUBBER-TIRED TRAIN, AND CONTROL METHOD AND SYSTEM THEREOF

(71) Applicant: CRRC NANJING PUZHEN CO., LTD., Nanjing, Jiangsu (CN)

(72) Inventors: Ye LIN, Nanjing, Jiangsu (CN); Pengcheng DAI, Nanjing, Jiangsu (CN); Chi ZNANG, Nanjing, Jiangsu (CN); Fang QI, Nanjing, Jiangsu (CN); Wei XIE, Nanjing, Jiangsu (CN); Jigui HU, Nanjing, Jiangsu (CN)

(73) Assignee: CRRC NANJING PUZHEN CO., LTD., Nanjing, Jiangsu (CN)

(21) Appl. No.: 17/913,140

(22) PCT Filed: Oct. 14, 2021
(86) PCT No.: PCT/CN2021/123694

§ 371 Date: Sep. 20, 2022

(30) Foreign Application Priority Data
Dec. 4, 2020 (CN) 202011398120.3

(51) Int. Cl. B62D 12/00; B62D 7/04; G05D 1/02

(52) U.S. Cl. CPC B62D 12/00; B62D 7/04; G05D 1/0259; G05D 1/027

(57) ABSTRACT

A rubber-tired train, and a control method and system thereof are disclosed. The train comprises multiple cars connected in series in turn, the cars include a relatively front car and a relatively rear car, and the front car is able to rotate in a horizontal plane relative to the rear car. The method comprises: acquiring a turning angle of a front car at a target position; determining a turning angle of a rear car at the target position according to the turning angle of the front car; and when it is determined that the rear car reaches the target position, controlling the rear car to steer according to the determined turning angle of the rear car. The rear car can follow the front car to steer, each car of the rubber-tired train can be controlled to steer accurately, allowing the rubber-tired train to run accurately along a preset running plan.

### FIELD

The application relates to rubber-tired train control technologies, in particular to a rubber-tired train, and a control method and system thereof.

### BACKGROUND

Rubber-tired trams with rubber wheels, also known as rubber-tired trains, do not need a platform beside tracks, because virtual tracks can be directly laid on existing urban roads, making the running environment of low-floor trams different from that of subways. Because of the virtual tracks, the rubber-tired trains do not have independent right of way, and there is overlap between the routes of the rubber-tired trains and pedestrians and vehicles. Therefore, the rubber-tired trains can run in a downtown area. Without the limitation of traditional steel rail routes, how to ensure that the rubber-tired trains run accurately along the virtual tracks has become an urgent problem.

### SUMMARY

In order to solve one of the above technical defects, embodiments of the application provide a rubber-tired train, and a control method and system thereof.

A first embodiment of the application provides a control method of a rubber-tired train. The rubber-tired train comprises multiple cars connected in series in turn, wherein the cars include a relatively front car and a relatively rear car, and the front car is able to rotate in a horizontal plane relative to the rear car. The method comprises:
acquiring a turning angle of the front car at a target position;
determining a turning angle of the rear car at the target position according to the turning angle of the front car; and
when it is determined that the rear car reaches the target position, controlling the rear car to steer according to the determined turning angle of the rear car.

A second embodiment of the application provides a control system of a rubber-tired train. The rubber-tired train comprises multiple cars connected in series in turn, wherein the cars include a relatively front car and a relatively rear car, and the front car is able to rotate in a horizontal plane relative to the rear car. The control system comprises:
a processing module used for acquiring a turning angle of the front car at a target position and determining a turning angle of the rear car at the target position according to the turning angle of the front car; and
a control module used for controlling the rear car to steer according to the determined turning angle of the rear car when it is determined that the rear car reaches the target position.

A third embodiment of the application provides a rubber-tired train, comprising multiple cars connected in series in turn and the aforementioned control system, wherein the cars include a relatively front car and a relatively rear car, and the front car is hinged to the rear car through a trailer bogie, so that the front car is able to rotate relative to the rear car.

The embodiments of the application provide a rubber-tired train, and a control method and system thereof. After a front car turns at a target position, whether a rear car reaches the target position will be determined, if so, the rear car will be controlled to turn, so that the rear car can follow the front car to steer, thereby controlling each car of the rubber-tired train to steer accurately, allowing the rubber-tired train to run accurately along a preset running plan; in addition, the required turning radius is small, which is conducive to the reduction of the construction cost of the virtual tracks of the rubber-tired train and the space occupation of roads.

### BRIEF DESCRIPTION OF THE DRAWINGS

The drawings described herein are used to provide a further understanding of the application and constitute a part of the application. The illustrative embodiments and descriptions of the application are used to explain the application, and do not constitute an improper limitation of the application. In the drawings:

FIG. 1 is a structural diagram of a rubber-tired train provided by an exemplary embodiment;

FIG. 2 is a flowchart of a control method provided by an exemplary embodiment;

FIG. 3 is a structural block diagram of a control system provided by an exemplary embodiment;

FIG. 4 is a perspective view of a bogie provided by an embodiment of the application;

FIG. 5 is a top view of a bogie provided by an embodiment of the application;

FIG. 6 is a perspective view of connection of two frame hinging parts in a bogie provided by an embodiment of the application;

FIG. 7 is a top view of two frame hinging parts when a train runs straight;

FIG. 8 is a top view of two frame hinging parts when a train goes through a curve;

FIG. 9 is an exploded view of connection of a frame and a slewing support device in a bogie provided by an embodiment of the application;

FIG. 10 is a cross-sectional view of a slewing bearing in a bogie provided by an embodiment of the application;

FIG. 11 is a cross-sectional view of a slewing support device in a bogie provided by an embodiment of the application;

FIG. 12 is a first structural diagram of a slewing support cover plate provided by an embodiment of the application;

FIG. 13 is a second structural diagram of a slewing support cover plate provided by an embodiment of the application;

FIG. 14 is a structural diagram of a bogie provided by an embodiment of the application, which is provided with a traction device;

FIG. 15 is a structural diagram of a traction device in a bogie provided by an embodiment of the application;

FIG. 16 is a front view of a traction rod in a bogie provided by an embodiment of the application;

FIG. 17 is a top view of a traction rod in a bogie provided by an embodiment of the application;

FIG. 18 is a partial end view of a traction rod in a bogie provided by an embodiment of the application;

FIG. 19 is a diagram of an installation structure of an air spring provided by an embodiment of the application;

FIG. 20 is a structural diagram of an air spring provided by an embodiment of the application;

FIG. 21 is a structural diagram of a lifting component provided by an embodiment of the application;

FIG. 22 is an exploded view of connection between a steering driving device and an axle in a bogie provided by the application;

FIG. 23 is a structural diagram of a chucking device provided by the application;

FIG. 24 is a use state diagram of the chucking device shown in FIG. 23;

FIG. 25 is a structural diagram of another chucking device provided by the application;

FIG. 26 is a sectional view of FIG. 25; and

FIG. 27 is a use state diagram of the chucking device shown in FIG. 25.

### DETAILED DESCRIPTION

In order to make the technical scheme and advantages of the embodiments of the application clearer, exemplary embodiments of the application will be described in detail below with reference to the attached drawings. Obviously, the described embodiments are merely illustrative ones, and are not all possible ones of the application. It should be noted that the embodiments in the application and the features in the embodiments can be combined with each other without conflict.

Rubber-tired trains can be seen in the market now. Compared with traditional buses, the rubber-tired trains have a larger transport capacity. The rubber-tired train has multiple articulated oars. The rubber-tired train usually comprises locomotives located at two ends to realize two-way operation, and at least one intermediate car can be arranged between the two locomotives. The larger the number of intermediate cars, the higher the transport capacity of the rubber-tired train. The specific number of intermediate cars can be set according to actual needs. Compared with traditional subways, light rails, trams, etc., the rubber-tired trains have a lower construction cost. For example, the rubber-tired train can use large-capacity lithium-ion supercapacitors for energy storage and power supply, and by equipping the whole train with large-capacity lithium-ion supercapacitors, the endurance and charging speed of the train are extremely high. In this way, there is no need to set up a power supply system along the route, and the power supply cost is greatly reduced.

Because for the rubber-tired trains, virtual tracks can be directly laid on existing urban roads, the running environment of low-floor trams is different from that of subways. Because of the virtual tracks, the rubber-tired trains do not have independent right of way, and there is overlap between the routes of the rubber-tired trains and pedestrians and vehicles. Therefore, the rubber-tired trains can run in a downtown area. However, without the limitation of traditional steel rail routes, how to ensure that the rubber-tired trains run accurately along the virtual tracks has become an urgent problem.

In order to solve the above technical problems, embodiments of the application provide a rubber-tired train, and a control method and system thereof. After a front car turns at a target position, whether a rear car reaches the target position will be determined, if so, the rear car will be controlled to turn, so that the rear car can follow the front car to steer, thereby controlling each car of the rubber-tired train to steer accurately, allowing the rubber-tired train to run accurately along a preset running plan; in addition, the required turning radius is small, which is conducive to the reduction of the construction cost of the virtual tracks of the rubber-tired train and the space occupation of roads.

The rubber-tired train, and the control method and system thereof provided in the embodiments are illustrated below with reference to the attached drawings in terms of functions and implementation processes.

To facilitate understanding, the rubber-tired train will be briefly described first. The rubber-tired train comprises multiple cars connected in sequence. For the convenience of description, the running direction of the rubber-tired train is taken as the front. The cars of the rubber-tired train include a front car and a rear car located behind the front car. The front car may be adjacent to the rear car, or there may be other cars between the front car and the rear car.

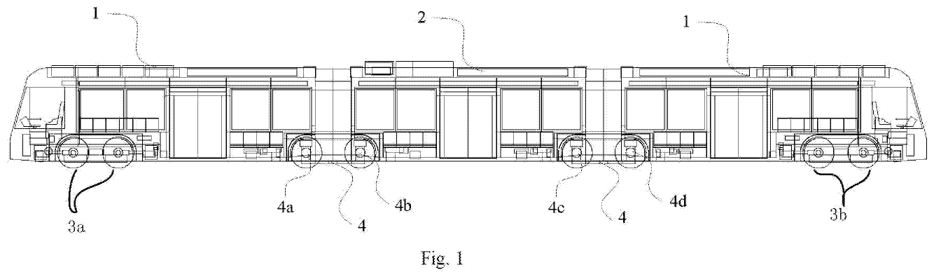

Specifically, as shown in FIG. 1, the rubber-tired train may comprise: two locomotives 1 located at two ends of the rubber-tired train, at least one intermediate car 2 connected between the two locomotives 1, a power bogie arranged at a bottom of an end, backing onto the intermediate car 2, of each locomotive 1, and trailer bogies 4 arranged at the joints between the intermediate car 2 and the locomotives 1. The trailer bogie 4 is an articulated bogie, so that two cars of the trailer bogie 4 can be steered separately.

For example, in the running direction of the train, the locomotive at the front end can be seen as the front car, and the intermediate car and the locomotive at the rear end can be seen as the rear cars behind the locomotive at the front end.

According to the control method of the rubber-tired train provided by the embodiments, the rubber-tired train comprises multiple cars connected in series in turn, wherein the cars include a relatively front car and a relatively rear car, and the front car is able to rotate in a horizontal plane relative to the rear car.

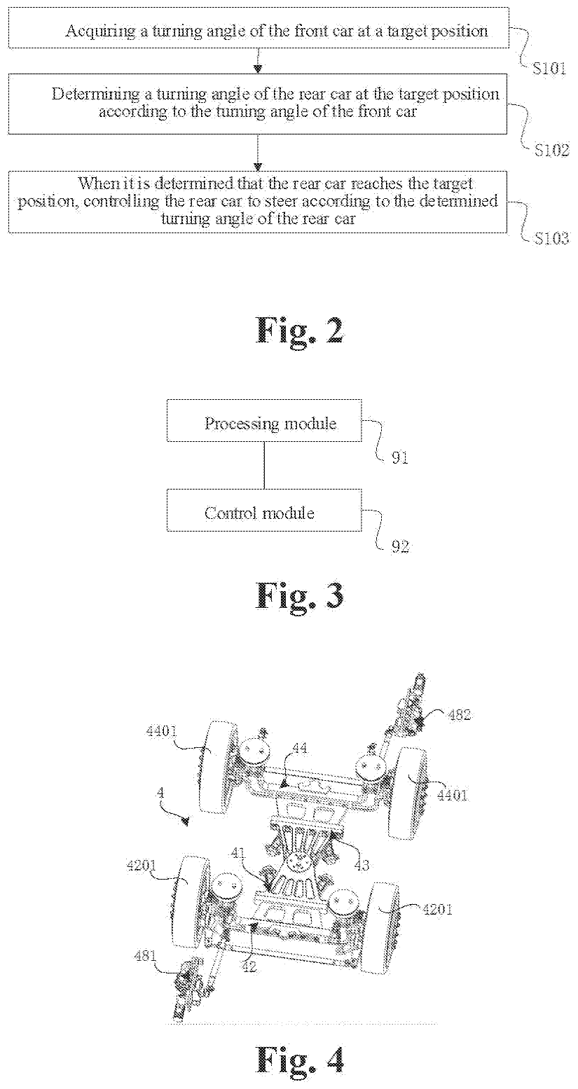

As shown in FIG. 2, the control method of the rubber-tired train comprises:
S101, acquiring a turning angle of the front car at a target position;
S102, determining a turning angle of the rear car at the target position according to the turning angle of the front car; and
S103, when it is determined that the rear car reaches the target position, controlling the rear car to steer according to the determined turning angle of the rear car.

In this example, for the convenience of description, the locomotive at the front end is taken as the front car, and the intermediate car and the locomotive at the rear end are taken as the rear cars. In other examples, the front car can be the intermediate car, the rear car can be the locomotive at the rear end, and the implementation process can be similar to that of this example.

In S101, the turning angle of the front car at the target position can be acquired according to a steering control instruction, and the steering control instruction may be issued by an automatic control system of the rubber-tired train or generated according to a steering angle of a steering wheel.

Specifically, the front car is the locomotive at the front end of the rubber-tired train. When the rubber-tired train is in an automatic driving mode, in some examples, S101 may comprise: acquiring a route deviation between a current route of the locomotive and a target running route; and determining a turning angle of a first wheelset of the front car at the target position according to the route deviation. The turning angle of the first wheelset at the target position can eliminate the deviation between the current route of the locomotive and the target running route. The target running route can be obtained from an electronic map of the rubber-tired train.

In other examples, the turning angle of the first wheelset of the locomotive can also be determined in advance according to a driving plan in the electronic map and other information. During the running of the rubber-tired train, steering control is performed according to the turning angle. Optionally, after the turning angle of the first wheelset of the locomotive is determined in advance according to the driving plan in the electronic map and other information, the route deviation between the current route of the locomotive and the target running route is acquired during the running of the train, and the turning angle determined based on the driving plan is corrected according to the route deviation. It should be noted that the way of determining the turning angle is not limited to this, and this embodiment is only an example.

When the rubber-tired train is in a manual driving (manual control) mode, S101 may comprise: receiving an input steering control instruction, and determining the turning angle of the first wheelset of the locomotive according to the steering control instruction. Specifically, a driver controls the steering wheel to rotate, the steering wheel transmits the rotating motion to a hydraulic steering gear through a steering shaft and a sprocket, and the hydraulic steering gear controls the first wheelset of the locomotive at the front end to steer. The hydraulic steering gear can convert the steering motion transmitted by the steering wheel into a corresponding electrical signal, so as to determine steering angles of other wheelsets. Alternatively, a turning angle sensor is arranged at the first wheelset of the locomotive, and the turning angle sensor is used for detecting the turning angle of the first wheelset, so as to determine the steering angles of other wheelsets according to the turning angle of the first wheelset. In addition, in the automatic driving mode, correction can be performed according to a detection result of the turning angle sensor.

In S102 and S103, when the front car, such as the locomotive at the front end, turns at the target position, the rear cars, such as the intermediate car and the locomotive at the rear end, can move along an established route, such as a straight line. After the locomotive at the front end passes through the target position, the rear car, such as the intermediate car, starts to turn at the target position, and its turning angle is the same as that of the front car. In this way, accurate steering of each car is ensured, so that accurate steering of the rubber-tired train is ensured.

Because each car starts to turn at the target position, after the turning angle of the front car at the target position is acquired, the turning angle of the front car at the target position can be taken as the turning angle of the rear car at the same target position. That is, the turning angle of the rear car at the target position may be the same as the turning angle of the front car.

Specifically, S102 comprises: determining the turning angle of each wheelset of each rear car (a first wheelset of each car and a second wheelset of each car) according to the turning angle of the first wheelset of the locomotive.

The method further comprises: determining a turning angle of a second wheelset at a bottom of the locomotive according to the turning angle of the first wheelset of the locomotive.

In the automatic driving mode, after the turning angle of the first wheelset of the locomotive at the front end is determined, turning angle information of each wheelset can be sent. In the manual driving mode, after acquiring the turning angle of the first wheelset of the locomotive at the front end, the turning angle information of the second wheelset of the locomotive at the front end and each wheelset of each rear car can be obtained.

In this example, the steering of the front car and the steering of the rear car at the target position are controlled separately. Compared with traditional rail vehicles, the rubber-tired train in this example has a smaller turning radius, which is conducive to the reduction of the construction cost of the virtual tracks of the rubber-tired train and the space occupation of roads.

For the convenience of description, the wheelsets arranged at the bottom of each car will be explained first. The bottom of each car is provided with a first wheelset and a second wheelset, wherein the second wheelset is located behind the first wheelset; that is, the front of the bottom of the car is provided with the first wheelset, and the rear of the bottom of the car is provided with the second wheelset.

As shown in FIG. 1, the power bogies and the trailer bogies usually have two wheelsets distributed in a spaced manner with one in front of the other. The wheelsets of the power bogic rotate synchronously. The front and rear wheelsets of the trailer bogie 4 are hinged, and can relatively rotate in the horizontal plane. The wheelset in this example comprise an axletree and wheels arranged at two ends of the axletree. The axletree 3a of the first wheelset of the locomotive at the front end 1 can be called an automatic axletree, the axle 4a of the second wheelset of the locomotive at the front end can be called a following axletree, the axletree 4b(4d) of the first wheelset of the rear car can be called a coordinating axletree, and the axletree 4c(3b) of the second wheelset of the rear car can be called a following axletree.

In this example, controlling the turning angle of each wheelset may specifically be controlling an angle of the corresponding axletree relative to a longitudinal center line (or transverse center line) of the train. When the axletree turns, the axletree drives the wheels at two ends to turn along with it, so as to drive the corresponding car to turn.

For the locomotive at the front end, the wheelsets of the power bogie at its front end form the first wheelset, a relatively front wheelset of the trailer bogie at its rear end forms the second wheelset of the locomotive at the front end, and a relatively rear wheelset of the trailer bogie forms the first wheelset of the intermediate car adjacent to the locomotive at the front end. For the locomotive at the rear end, a relatively rear wheelset in the trailer bogie at the front of the bottom of the locomotive at the rear end forms the first wheelset of the locomotive at the rear end, and the power bogie at the rear of the bottom of the locomotive at the rear end forms the second wheelset of the locomotive at the rear end. For the intermediate car, a relatively rear wheelset in the trailer bogie at the front of the bottom forms the first wheelset, and a relatively front wheelset in the trailer bogie at the rear of the bottom forms the second wheelset.

Optionally, controlling the car to steer comprises: controlling the first wheelset to steer when the first wheelset at the bottom of the car reaches the target position; and controlling the second wheelset to steer when the second wheelset at the bottom of the car reaches the target position.

Illustratively, the target position is located at the joint of two straight line sections. When the first wheelset at the bottom of the current car does not reach the target position, the first wheelset at the bottom of the current car moves linearly along a straight line section; when the first wheelset at the bottom of the current car reaches the target position, the first wheelset at the bottom of the current car is controlled to steer, and after the first wheelset at the bottom of the current car passes through the target position, the first wheelset at the bottom of the current car moves linearly along the straight line section.

When the first wheelset at the bottom of the current car reaches the target position but the second wheelset at the bottom of the current car has not yet reached the target position, the second wheelset can move linearly along the straight line section; after the first wheelset at the bottom of the current car passes through the target position and the second wheelset at the bottom of the current car just reaches the target position, the second wheelset at the bottom of the current car is controlled to steer, and after the second wheel at the bottom of the current car passes through the target position, the second wheelset at the bottom of the current car moves linearly along the straight line section.

It can be understood that before the first wheelset at the bottom of the current car reaches the target position or after the first wheelset at the bottom of the current car passes through the target position, the type of running line can be determined according to the target route of the rubber-tired train, and is not limited to the straight line section. Similarly, before the second wheelset at the bottom of the current car reaches the target position or after the second wheelset at the bottom of the current car passes through the target position, the type of running line can be determined according to the target route of the rubber-tired train, and is not limited to the straight line section.

In this example, by controlling the first wheelset and the second wheelset at the bottom of the car to turn at the target position separately, the demand for the turning radius is reduced, and the construction cost of the virtual tracks of the rubber-tired train and the space occupation of roads are also reduced.

In one possible implementation, the steering of the first wheelset can be triggered according to the position of the car itself.

Specifically, controlling the first wheelset to steer when the first wheelset at the bottom of the car reaches the target position comprises:
acquiring position information of the car; and
controlling the first wheelset to steer when it is determined that the first wheelset at the bottom of the car reaches the target position according to the position information of the car.

Controlling the second wheelset to steer when the second wheelset at the bottom of the car reaches the target position comprises:
acquiring position information of the car; and
controlling the second wheelset to steer when it is determined that the second wheelset at the bottom of the car reaches the target position according to the position information of the car.

The position information of the current car can be determined by the induction between a magnetic induction module at the bottom of the current car and a magnetic mark on the road. Alternatively, each car can be provided with a navigation module, and the position information of the current car can be determined according to navigation information of the navigation module.

In another possible implementation, the steering of the first wheelset can be triggered according to mileage of the locomotive and a distance between the corresponding wheelset and the first wheelset of the locomotive at the front end.

Specifically, the front car is the locomotive located at the front end of the rubber-tired train.

Controlling the first wheelset to steer when the first wheelset at the bottom of the car reaches the target position comprises:
acquiring mileage of the locomotive; and
controlling the first wheelset of the rear car to steer when it is determined that the first wheelset of the rear car reaches the target position according to the mileage of the locomotive and a distance between the first wheelset of the rear car and the first wheelset at the bottom of the locomotive.

Controlling the second wheelset to steer when the second wheelset at the bottom of the car reaches the target position comprises:
acquiring mileage of the locomotive; and
controlling the second wheelset at the bottom of the locomotive to steer when it is determined that the second wheelset at the bottom of the locomotive reaches the target position according to the mileage of the locomotive and a distance between the second wheelset at the bottom of the locomotive and the first wheelset at the bottom of the locomotive, or
controlling the second wheelset of the rear car to steer when it is determined that the second wheelset of the rear car reaches the target position according to the mileage of the locomotive and a distance between the second wheelset of the rear car and the first wheelset at the bottom of the locomotive.

The mileage of the locomotive can be determined according to speed information detected by a speed sensor and running time of the vehicle. Alternatively, the current position information of the locomotive is determined according to information obtained by a vision module, a navigation module or a magnetic induction module, and the mileage of the locomotive is determined according to the current position information, an electronic map and other information.

Optionally, in order to improve the accuracy of the acquired mileage, acquiring the mileage of the locomotive comprises:
acquiring the number of magnetic nails arranged on the ground detected by a magnetic sensor and a current vehicle speed detected by a speed sensor; and
determining the mileage of the locomotive according to the number of the magnetic nails and the current vehicle speed.

Specifically, determining the mileage of the front car according to the number of the magnetic nails and the current vehicle speed comprises:
determining the mileage of the front car according to the following formula:

S=M×D+(t₂−t₁)×V;
where S is the mileage of the front car, M is the number of the magnetic nails, D is a preset distance between adjacent magnetic nails, V is a current vehicle speed, t₂ is a current time when the speed sensor sends signals, and t₁ is a current time when the magnetic sensor sends signals. It can be understood that when t₁=t₂, S=M×D.

The embodiments further provide a control system of the rubber-tired train, which is used to implement the steps in the above-mentioned method embodiment, and the implementation process is the same as that of the above-mentioned embodiment, and will not be repeated here.

According to the control system of the rubber-tired train provided by the embodiments, the rubber-tired train comprises multiple cars connected in series in turn, wherein the cars include a relatively front car and a relatively rear car, and the front car is able to rotate in a horizontal plane relative to the rear car.

As shown in FIG. 3, the control system comprises:
a processing module 91 used for acquiring a turning angle of the front car at a target position and determining a turning angle of the rear car at the target position according to the turning angle of the front car; and
a control module 92 used for controlling the rear car to steer according to the determined turning angle of the rear car when it is determined that the rear car reaches the target position.

Optionally, the front of a bottom of the car is provided with a frat wheelset, and the rear of the bottom of the car is provided with a second wheelset. The control module 92 is specifically used for controlling the first wheelset to steer when the first wheelset at the bottom of the car reaches the target position and controlling the second wheelset to steer when the second wheelset at the bottom of the car reaches the target position.

Optionally, the control module 92 is specifically used for acquiring position information of the car, and controlling the first wheelset to steer when it is determined that the first wheelset at the bottom of the car reaches the target position according to the position information of the car.

Optionally, the control module 92 is specifically used for acquiring position information of the car, and controlling the second wheelset to steer when it is determined that the second wheelset at the bottom of the car reaches the target position according to the position information of the car.

Optionally, the front car is a locomotive at a front end of the rubber-tired train. The control module 92 is specifically used for acquiring mileage of the locomotive, and controlling the first wheelset of the rear car to steer when it is determined that the first wheelset of the rear car reaches the target position according to the mileage of the locomotive and a distance between the first wheelset of the rear car and the first wheelset at the bottom of the locomotive.

Optionally, the front car is a locomotive at a front end of the rubber-tired train. The control module 92 is specifically used for acquiring mileage of the locomotive, and controlling the second wheelset at the bottom of the locomotive to steer when it is determined that the second wheelset at the bottom of the locomotive reaches the target position according to the mileage of the locomotive and a distance between the second wheelset at the bottom of the locomotive and the first wheelset at the bottom of the locomotive, or controlling the second wheelset of the rear car to steer when it is determined that the second wheelset of the rear car reaches the target position according to the mileage of the locomotive and a distance between the second wheelset of the rear car and the first wheelset at the bottom of the locomotive.

Optionally, the control module 92 is specifically used for acquiring the number of magnetic nails arranged on the ground detected by a magnetic sensor and a current vehicle speed detected by a speed sensor; and determining the mileage of the locomotive according to the number of the magnetic nails and the current vehicle speed.

Optionally, the control module 92 is specifically used for determining the mileage of the front car according to the following formula:

S=M×D+(t₂−t₁)×V;
where S is the mileage of the front car, M is the number of the magnetic nails. D is a preset distance between adjacent magnetic nails. V is a current vehicle speed, t₂ is a current time when the speed sensor sends signals, and t₁ is a current time when the magnetic sensor sends signals.

Optionally, the front car is a locomotive at a front end of the rubber-tired train. The processing module 91 is specifically used for acquiring a route deviation between a current route of the locomotive and a target running route; and determining a turning angle of a first wheelset of the front car at the target position according to the route deviation.

Optionally, the front car is a locomotive at a front end of the rubber-tired train. The processing module 91 is specifically used for receiving an input steering control instruction, and determining the turning angle of the first wheelset of the locomotive according to the steering control instruction.

Specifically, the front car is a locomotive at a front end of the rubber-tired train. The processing module 91 is specifically used for determining the turning angle of each wheelset of each rear car according to the turning angle of the first wheelset of the locomotive. The processing module 91 is further used for determining the turning angle of the second wheelset at the bottom of the locomotive according to the turning angle of the first wheelset of the locomotive.

The embodiments provide a rubber-tired train, which comprises multiple cars connected in series in turn and the control system in the above example, wherein the cars include a relatively front car and a relatively rear car, and the front car is hinged to the rear car through a trailer bogie, so that the front car is able to rotate relative to the rear car. The functions and implementation process of a control system are the same as those of the previous examples, and will not be repeated here.

The trailer bogie comprises axles, frames, suspension devices and a traction device. As shown in FIGS. 4 and 5, the number of the axles is two. When the train runs straight, the two axles are parallel to each other and extend in a width direction of the train. When the train passes through a curve, the ends of the two axles on the same side are close to each other and the ends on the other side are away from each other. Two ends of each axle are respectively provided with wheels which are able to rotate relative to the axle. The number of the frames is two, which extend in a direction perpendicular to the axles and are located between the two axles. One end of the frame is connected to the adjacent axle, and the other end is hinged to the other frame. The two frames can rotate relatively in the horizontal plane, and the two frames rotate relatively to drive the axles to deflect. The suspension devices are symmetrically arranged on the axles, specifically, the suspension devices are symmetrically arranged at two ends of the axle, and the suspension devices on the two axles are symmetrically arranged. A bottom of the suspension device is connected to the axle, and a top is connected to a vehicle body of the train to cushion the vertical force between the bogie and the vehicle body. One end of the traction device is connected to the axle, and the other end is connected to the vehicle body, which is used to transfer the traction and braking force between the bogic and the vehicle body.

The embodiments provide a specific implementation. As a trailer bogie, the bogie is connected between two adjacent vehicle bodies. As shown in FIGS. 4 and 5, the two frames are referred to as a first frame 41 and a second frame 43, and the two axles are referred to as a first axle 42 and a second axle 44. The first axle 42 and the second axle 44 are respectively connected to bottoms of two adjacent vehicle bodies, and the first frame 41 and the second frame 43 rotate relatively, so as to better adapt to the turning of the train and reduce the turning radius. Specifically, two ends of the first frame 41 in a longitudinal direction are respectively called a first end and a second end, wherein the first end is hinged to the second frame 43 and the second end is connected to the first axle 42. Two ends of the first axle 42 are connected to first trailer wheels 4201. Two ends of the second frame 43 in the longitudinal direction are called a first end and a second end respectively, wherein the first end is hinged to the first frame 41 and the second end is connected to the second axle 44. Two ends of the second axle 44 are connected to second trailer wheels 4401.

A hinging connection structure between the first frame 41 and the second frame 43 can be set as required. For example, the first end of the first frame 41 and the first end of the second frame 43 may be hinged by a hinge pin, and both of them can rotate relative to the hinge pin. In this way, when the first frame 41 or the second frame 43 rotates, the corresponding second frame 43 or first frame 41 can rotate accordingly to some extent because of the hinging connection relationship.

According to the technical scheme provided by the embodiments, the two axles connected to wheels are adopted, and the two frames extending in the direction perpendicular to the axles are arranged between the two axles, one end of the frame is connected to the adjacent axle and the other end is hinged to the other frame, and the two frames can rotate relatively in the horizontal plane to drive the two axles to deflect relatively, so that the turning radius can be reduced, and the curve passing performance of the vehicle is better. In addition, in the embodiments, the suspension devices are symmetrically arranged on the axles for buffering the vertical force between the vehicle body and the bogie, one end of the traction device is connected to the axle, and the other end is connected to the vehicle body, so as to transfer the traction and braking force between the vehicle body and the bogie.

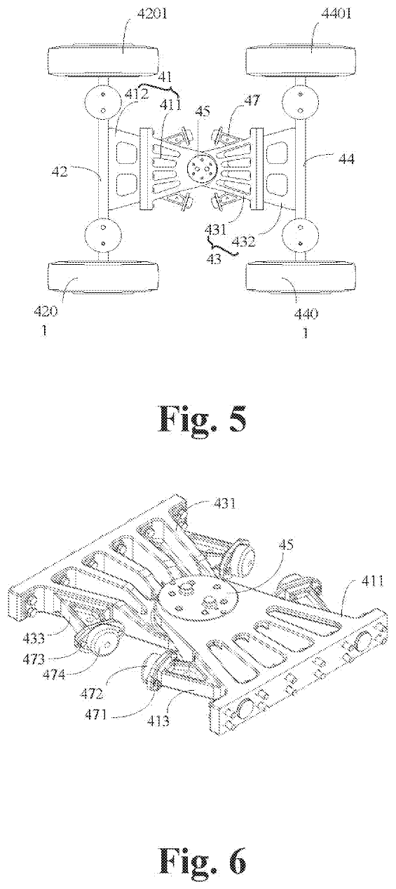

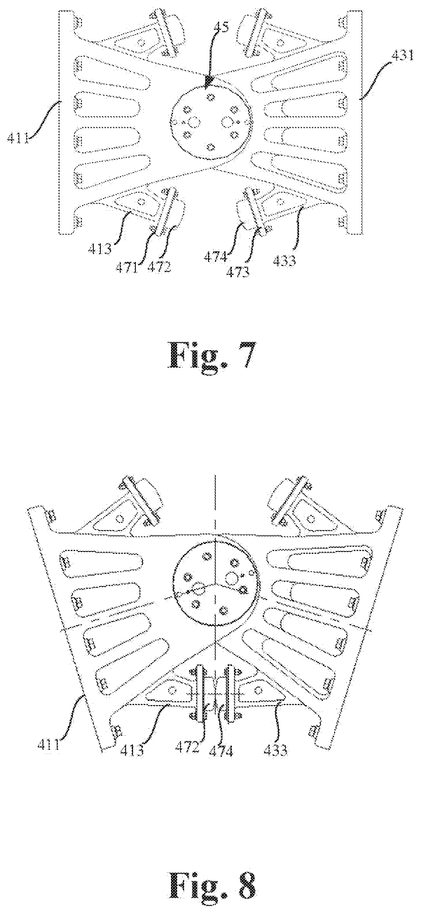

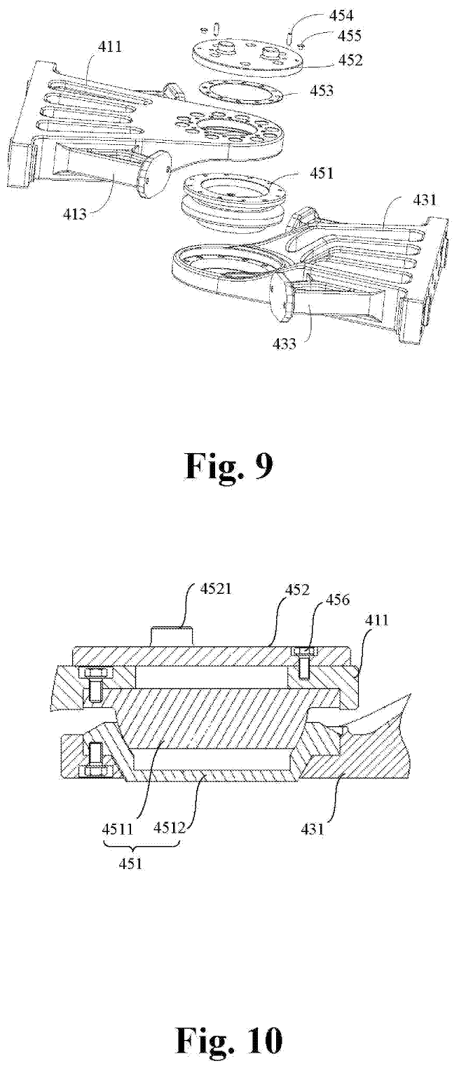

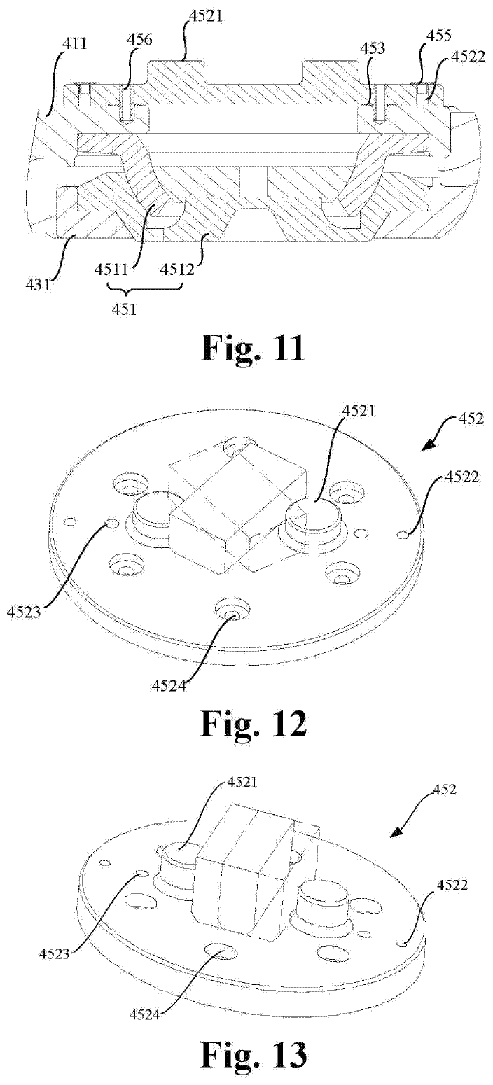

For the first frame and the second frame, the embodiments provide a specific implementation. As shown in FIGS. 4, 5, 6, 7, 8, 9, 10, 11, 12 and 13, a frame buffer device is provided, which can be arranged on at least one frame to serve as a buffer when the two frames are in rotary contact. The two frames are connected by a slewing support device, and the slewing support device comprises a first rotator and a second rotator which can relatively rotate in the horizontal plane and are connected to the two frames respectively.

The frame comprises a frame connecting part and a frame hinging part. The frame connecting part is connected between the axle and the frame hinging part, and the frame buffer devices are symmetrically arranged on two sides of the frame hinging part in the horizontal direction. An end, away from the frame connecting part, of the frame hinging part is connected to the first rotator or the second rotator. The frame is provided with a stepped hole and a stepped surface, the first rotator and the second rotator are arranged with one above the other, and the second rotator is fixed on the stepped surface of one of the frames. A bottom of the first rotator is embedded in the second rotator, and a top of the first rotator protrudes from the second rotator and is fixed on the stepped surface of the other frame.

In addition, the slewing support device also comprises a slewing support cover plate which is installed on the frame and seals a first stepped hole. A waterproof pad is arranged between the slewing support cover plate and the lower frame, an elastic pin extending vertically is arranged between the slewing support cover plate and the lower frame, and the elastic pin passes through the waterproof pad to be fixed to the frame.

Specifically, the first frame 41 comprises a first frame hinging part 411 and a first frame connecting part 412. The first frame connecting part 412 is connected between the first axle 42 and the first frame hinging part 411. The second frame 43 comprises a second frame hinging part 431 and a second frame connecting part 432. The second frame connecting part 432 is connected between the second axle 44 and the first frame hinging part 411. The first frame hinging part 411 and the second frame hinging part 431 are connected by a slewing support device 45.

The slewing support device 45 comprises a slewing bearing 451, which comprises a first rotator 4511 and a second rotator 4512 which are rotationally matched with each other, and their rotational axes are perpendicular to the ground. The first rotator 4511 can be connected to the first frame 41, and the second rotator 4512 can be connected to the second frame 43, that is, the first frame 41 and the second frame 43 are rotatably connected by the slewing bearing 451.

Specifically, the first frame 41 is fixedly connected to the first rotator 4511 through a fastener, the first end of the first frame 41 is provided with a first stepped hole, which comprises a first aperture section and a second aperture section, and the aperture of the first aperture section is greater than that of the second aperture section, so as to form a first stepped surface at a transitional joint between the first aperture section and the second aperture section. The first aperture section can be arranged close to the first rotator 4511, so that the first rotator 4511 is mounted below the first stepped surface.

Similarly, the second frame 43 is fixedly connected to the second rotator 4512 through a fastener, the first end of the second frame 43 is provided with a second stepped hole, which comprises a third aperture section and a fourth aperture section, and the aperture of the third aperture section is greater than that of the fourth aperture section, so as to form a second stepped surface at a transitional joint between the third aperture section and the fourth aperture section. The third aperture section can be arranged close to the second rotator 4512, so that the second rotator 4512 is fixed above the second stepped surface.

In one implementation, the first rotator 4511 and the second rotator 4512 are arranged with one above the other, and the rotation axes of the first rotator 4511 and the second rotator 4512 are perpendicular to the ground or the first and second stepped surfaces. The first rotator 4511 comprise a first mounting surface and a bowl-shaped spherical structure protruding from the first mounting surface, an upper bottom surface of the bowl-shaped spherical structure is fixed on the first mounting surface, and a lower bottom surface of the bowl-shaped spherical structure faces the second rotator 4512. The second rotator 4512 comprises a second mounting surface and a second spherical hole, and the second spherical hole is matched with the bowl-shaped spherical structure and faces the first rotator 4511.

A second mounting surface of the second rotator 4512 is attached to the second stepped surface, and is connected to the second stepped surface by a bolt, and the second rotator 4512 is embedded in the second frame 43. The first mounting surface of the first rotator 4511 is attached to the first stepped surface, and is connected to the first stepped surface by a bolt. Part of the bowl-shaped spherical structure is inserted into the second spherical hole, and a side face of the bowl-shaped spherical structure is attached to a hole wall of the second spherical hole. A certain gap exists between the first frame 41 and the second frame 43 in the vertical direction, so that the bowl-shaped spherical structure can tilt to one side in the second spherical hole, that is, the first rotator 4511 and the second rotator 4512 not only can rotate around the rotation axis, but also can realize eccentric rotation.

In another implementation, the first rotator 4511 and the second rotator 4512 are arranged with one above the other, the first rotator 4511 is provided with a first mounting surface, and the first mounting surface is attached and fixed to a first stepped surface; the second rotator 4512 is provided with a second mounting surface, and the second mounting surface is attached and fixed to a second stepped surface; the second rotator 4512 is provided with a bowl-shaped spherical structure, the first rotator 4511 is provided with a first spherical hole matched with the bowl-shaped spherical structure, and a side face of the bowl-shaped spherical structure is attached to a side wall of the first spherical hole; and a certain gap exists between the first frame 41 and the second frame 43 in the vertical direction, so that the bowl-shaped spherical structure can tilt to one side in the first spherical hole, that is, the first rotator 4511 and the second rotator 4512 not only can rotate around the rotation axis, but also can realize lateral deflection.

In this embodiment, the first rotator 4511 and the second rotator 4512 are arranged with one above the other, and the rotation axes of the first rotator 4511 and the second rotator 4512 are perpendicular to the ground or the first stepped surface and the second stepped surface. The second mounting surface of the second rotator 4512 is attached to the second stepped surface, and is connected to the second stepped surface by a bolt, and the second rotator 4512 is embedded in the second frame 43. The first mounting surface of the first rotator 4511 is attached to the first stepped surface, and is connected to the first stepped surface by a bolt, and a certain gap exists between the first frame 41 and the second frame 43, so that the first rotator 4511 and the second rotator 4512 have a certain lateral deflection ability in the process of rotating around the rotation axis, which can improve the curve passing performance and adaptability of the vehicle.

In this embodiment, a slowing support cover plate 452 is further arranged above the first frame 41, and the slewing support cover plate 452 is used for sealing the first stepped hole of the first frame 41. The slowing support cover plate 452 can be a circular plate, which is arranged at the first end of the first frame 41 and attached and fixed to a surface of the first frame 41 to seal the first stepped hole. For example, the slewing support cover plate 452 is arranged at the first stepped hole in a covering mode and fixed on the first frame 41. With this arrangement, dust, foreign matter, rainwater and the like can be prevented from entering the slewing support, so that the reliability of a slewing support device 45 can be improved.

Two through passage limit bosses 4521 are arranged on a side, away from the first frame 41, of the slewing support cover plate 452, and the two through passage limit bosses 4521 are arranged on the slewing support cover plate 452 in a spaced manner and protrude from a surface of the slewing support cover plate 452, so as to form a through passage limit space.

A through passage is a passage connecting two vehicle bodies, the bogie is connected between the two vehicle bodies, and the slewing support cover plate 452 is located below the through passage. On a bottom surface, facing the slewing support cover plate 452, of the through passage, a through passage limit block is provided, and the through passage limit block can be embedded in the limit space. The through passage limit block is limited between the two through passage limit bosses 4521, and the through passage limit bosses 4521 can limit the deformation and rotation angle of the through passage.

For example, the two through passage limit bosses 4521 can be arranged in a central area of the slewing support cover plate 452 and symmetrically distributed on the slewing support cover plate 452. The slewing support cover plate 452 can be a circular slewing support cover plate 452, the two through passage limit bosses 4521 are symmetrically arranged along a center of the slewing support cover plate 452, and the two through passage limit bosses 4521 have a certain distance therebetween, which serves as a space allowing the through passage limit block to be inserted therein. Along the length direction of the bogie, the two through passage limit bosses 4521 are located on the left and right sides of the through passage limit block respectively, so as to limit the deformation and turning angle of the through passage, preventing excessive deformation and rotation of the through passage.

On the basis of the above implementation, an annular waterproof pad 453 is further arranged between the slewing support cover plate 452 and the first frame 41, which can prevent water from entering the slewing bearing 451 to avoid corrosion of the slewing bearing 45, so as to improve the rotation reliability of the first frame 41 and the second frame 43.

Specifically, a side, facing the first frame 41, of the slewing support cover plate 452 is provided with a sinking platform to form an installation space for the waterproof pad 453, and the waterproof pad 453 is arranged around the second stepped hole. One side of the waterproof pad 453 abuts against the slewing support cover plate 452 and the other side abuts against the first frame 41, and the free thickness of the waterproof pad 453 is greater than the depth of the sinking platform. After installation, the waterproof pad 453 is in a compressed state. By compressing the waterproof pad 453, the waterproof effect between the slewing support cover plate 452 and the first frame 41 can be improved.

Further, the slewing support cover plate 452 is fixed on the first frame 41 by a plurality of cover plate fasteners 456. For example, the plurality of cover plate fasteners 456 are arranged at equal intervals in the circumferential direction of the slewing support cover plate 452, and the first frame 41 is provided with cover plate fastener mounting holes 4524 matched with the cover plate fasteners 456. The cover plate fastener 456 may be a fastening bolt, and the cover plate fastener mounting hole 4524 provided in the first frame 41 may be a threaded hole. One end of the cover plate fastener 456 passes through a gasket and the slewing support cover plate 452 and is fixed on the first frame 41, thereby fixing the slewing support cover plate 452 on the first frame 41.

On the basis of the above implementation, the cover plate fasteners 456 can be arranged opposite to the waterproof pad 453 to improve the waterproof effect between the first frame 41 and the slewing support cover plate 452. For example, the waterproof pad 453 is arranged opposite to the cover plate fasteners 456, and the waterproof pad 453 is provided with through holes through which the cover plate fasteners 456 pass, that is, one end of the cover plate fastener 456 passes through the slewing support cover plate 452 and the waterproof pad 453 and is fixed on the first frame 41, so that the waterproof effect between the slewing support cover plate 452 and the first frame 41 can be improved.

In order to prevent the cover plate fasteners 456 from breaking when the slewing support cover plate 452 is impacted by the through passage, an elastic pin 454 is further provided between the slewing support cover plate 452 and the first frame 41 in this embodiment, and the elastic pin 454 is used for resisting the impact on the slewing support cover plate 452 by the through passage. Specifically, two elastic pins 454 are arranged between the slewing support cover plate 452 and the first frame 41. The two elastic pins 454 are respectively located on the outer sides, away from the through passage, of the two through passage limit bosses 4521, and the elastic pins 454 are arranged opposite to the through passage limit bosses 4521. For example, the slewing support cover plate 452 is provided with two elastic pin mounting holes 4523, the two through passage limit bosses 4521 are located between the two elastic pin mounting holes 4523, and the elastic pins 454 are inserted into the elastic pin mounting holes 4523 and fixed on the first frame 41. The impact received by the through passage limit bosses 4521 can be transmitted to the elastic pins 454 along a straight line, so as to improve the impact counteracting effect.

Further, the elastic pins 454 can be arranged opposite to the waterproof pad 453, the waterproof pad 453 is provided with through holes for the elastic pins 454 to pass through, and one end of the elastic pin 454 passes through the slewing support cover plate 452 and the waterproof pad 453 and is inserted into the first frame 41. With this arrangement, the waterproof effect of the waterproof pad 453 on the slewing support cover plate 452 and the first frame 41 can be improved.

On the basis of the above implementation, the slewing support cover plate 452 in this embodiment is further provided with a withdrawal threaded hole 4522 and a sealing plug 455 for sealing the withdrawal threaded hole 4522, and the withdrawal threaded hole 4522 runs through the slewing support cover plate 452. When the slewing support cover plate 452 needs to be disassembled, the sealing plug 455 is disassembled from the withdrawal threaded hole 4522, so that one end of the withdrawal threaded hole 4522 is open, then a tool bolt is screwed into the withdrawal threaded hole 4522, an end of the tool bolt abuts against the first frame 41, and an external force is applied to the tool bolt to separate the slewing support cover plate 452 from the first frame 41. Accordingly, when it is not necessary to disassemble the slewing support cover plate 452, the sealing plug 455 is mounted in the withdrawal threaded hole 4522 and seals the withdrawal threaded hole 4522.

The frame is provided with two frame buffer devices which are symmetrically arranged on two sides of the frame with a symmetry axis being perpendicular to the axle. The frame buffer device comprises a buffer block mounting base and a buffer block, wherein the buffer block mounting base is fixed on the frame, and the buffer block is fixed on the buffer block mounting base. The buffer blocks on the same side of the two frames are oppositely arranged. When the two axles are parallel, the buffer blocks located on the same side of the two frames do not make contact. When the two frames rotate relatively by a predetermined angle, the buffer blocks on the side, same as the rotation direction, of the two frames can abut against each other.

One implementation is that buffer base mounting arms extend from two sides of the frame for mounting the buffer block mounting bases, and a preset included angle is formed between the buffer base mounting arm and the extension direction of the frame.

Specifically, in the direction from the first axle 42 to the second axle 44, the first end of the first frame 41 is symmetrically provided with two frame buffer devices 47, and the first end of the second frame 43 is symmetrically provided with two frame buffer devices 47. To facilitate the description of this embodiment, the frame buffer devices 47 provided on the first frame 41 can be defined as first frame buffer devices, and the frame buffer devices 47 provided on the second frame 43 can be defined as second frame buffer devices.

The first frame buffer device is matched with the second frame buffer device, and when the first frame 41 and the second frame 43 rotate by a certain angle, the first frame buffer device and the second frame buffer device can abut against each other. Further, the first frame buffer device and the second frame buffer device located on the same side can be located on the same rotation path. When the first frame 41 and the second frame 43 rotate relatively, a gap between the first frame buffer device and the second frame buffer device gradually decreases until the first frame buffer device and the second frame buffer device contact each other, which provides a buffer force for the first frame 41 and the second frame 43, thus avoiding rigid contact between the first frame 41 and the second frame 43. Upon continuous pressing, the first frame buffer device and the second frame buffer device are no longer elastically deformed, so that the first frame 41 and the second frame 43 can be limited to achieve the purpose of rigidity limitation, thereby limiting the turning angle between the first frame 41 and the second frame 43.

In one implementation, the first frame buffer device comprises a first buffer block 472 and a first buffer block mounting base 471, the first buffer block mounting base 471 is used for mounting the first buffer block 472, and the first buffer block mounting base 471 is mounted on the first frame 41 through a first buffer base mounting arm 413. It can be understood that the first frame buffer device is a part compounded by the buffer block made of rubber and the metal mounting base with a certain process. The metal mounting base is fixedly connected to the first buffer base mounting arm 413, and the rubber buffer block is suspended and used as a buffer.

The first buffer base mounting arm 413 may be an arc-shaped retaining arm, and its bending extension direction is consistent with the rotation direction of the first frame 41. One end of the first buffer base mounting arm 413 is fixedly connected to the first frame 41, and the first buffer block mounting base 471 is fixed to the other end of the first buffer base mounting arm 413.

Similarly, the second frame buffer device comprises a second buffer block 474 and a second buffer block mounting base 473, and the second frame buffer device is mounted on the second frame 43 through a second buffer base mounting arm 433. The structure of the second buffer base mounting arm 433 can be determined by referring to the structure of the first buffer base mounting arm 413, and will not be repeated here.

Preferably, when the first frame buffer device and the second frame buffer device are in contact, the first buffer block 472 and the second buffer block 474 can make contact on front sides, and the first buffer block 472 faces second rubber, so as to provide the maximum buffer for the first frame buffer device and the second frame buffer device, and reduce the vibration and noise caused by impact during the rotation of the first frame 41 and the second frame 43.

On the basis of the above implementation, the first frame 41 and the second frame 43 provided in this embodiment are each of a split structure. The first frame 41 comprises a first frame connecting part 412 connected to the first axle 42 and a first frame hinging part 411 connected to the first frame connecting part 412. The first frame connecting part 412 is fixedly connected to the first axle 42, or the first frame connecting part 412 and the first axle 42 can be made into an integral structure.

One end of the first frame hinging part 411 is fixedly connected to the first frame connecting part 412 by a bolt, and the other end of the first frame hinging part 411 is connected to the first rotator 4511 of the slewing bearing 451. Two sides of the first frame hinging part 411 are respectively provided with the first buffer base mounting arms 413, and the first buffer base mounting arms 413 and the first frame hinging part 411 can form an integral structure, so as to enhance the connection strength between the first buffer base mounting arms 413 and the first frame hinging part 411.

Similarly, the second frame 43 comprises a second frame connecting part 432 connected to the second axle 44, and a second frame hinging part 431 connected to the second frame connecting part 432, the second frame connecting part 432 is fixedly connected to the second axle 44, or the second frame connecting part 432 and the second axle 44 can be made into an integral structure. One end of the second frame connecting part 432 is fixedly connected to the second frame hinging part 431 by a bolt, and the other end of the second frame hinging part 431 is connected to the second rotator 4512 of the slewing bearing 451. Two sides of the second frame hinging part 431 are respectively provided with the second buffer base mounting arms 433, and the second buffer base mounting arms 433 and the second frame hinging part 431 can form an integral structure, so as to enhance the connection strength between the second buffer block mounting base 473 and the second frame hinging part 431.

In order to increase the turning angle between the first frame 41 and the second frame, the width of the end, connected to the frame connecting part, of the corresponding frame hinging part is greater than that of the end connected to the other frame, and the width of the frame hinging part gradually decreases in the direction from the axle to a frame hinging position. Specifically, the first frame 41 and the second frame 43 form a triangular or trapezoidal structure, the second end of the first frame 41 is connected to the first axle 42, the first end is connected to the slewing bearing 451, the second end of the second frame 43 is connected to the second axle 44, and the first end of the second frame 43 is connected to the slewing bearing 451. In this way, ends, close to the slewing bearing 451, of the first frame 41 and the second frame 43 form a large rotating space, which meets the rotating angle requirements of the first frame 41 and the second frame 43.

On the basis of the above implementation, the first frame 41 and the second frame 43 are also provided with hollowed-out structures to reduce the weight of the first frame 41 and the second frame 43. Specifically, the first frame connecting part 412 and the first frame hinging part 411 of the first frame 41 are respectively provided with hollowed-out structures. Specifically, the first frame hinging part is provided with a plurality of vertical through holes to form the hollowed-out structure. A side wall, facing the frame connecting part, of the through hole is provided with a bolt hole of which a center line extends in the horizontal direction, so as to be connected to the frame connecting part by a bolt passing through the bolt hole. For example, the first frame connecting part 412 may be provided with a first hollowed-out structure, which comprises two trapezoidal holes or square holes symmetrically arranged on the first frame connecting part 412, wherein the number of the trapezoidal holes or square holes in the hollowed-out structure is related to the arrangement of connecting bolts, and uniformly arranged trapezoidal or square holes are beneficial to uniform force transmission. The size of the hollowed-out space is determined by fully considering the bolt installation and fastening operation space. In this embodiment of the application, the hollowed-out structures being made to be trapezoidal or square is based on the size change of two ends of connection, which facilitates gradual transition and avoids stress concentration.

The first frame hinging part 411 can be provided with a second hollowed-out structure, which comprises a plurality of elongated holes, and the elongated holes can be symmetrically arranged in the first frame hinging part 411. The extension direction of the elongated holes is parallel to the extension direction of the first frame hinging part 411. In this way, the elongated holes are consistent with the bolt arrangement direction and the direction of large longitudinal forces such as traction and braking force, which is beneficial to uniform force application to bolts.

Further, the second frame connecting part 432 and the second frame hinging part 431 of the second frame 43 are provided with hollowed-out structures. For example, the second frame connecting part 432 can be provided with a third hollowed-out structure, and the third hollowed-out structure can be set by referring to the first hollowed-out structure. The second frame hinging part 431 can be provided with a fourth hollowed-out structure, and the fourth hollowed-out structure can be set by referring to the second hollowed-out structure, which will not be repeated here.

The frame connecting part is of a trapezoidal structure, of which a long bottom edge is connected to the axle, and a short bottom edge is connected to the frame hinging part. The structures of both the first frame connecting part and the second frame connecting part may be the above-mentioned trapezoidal structures. A connecting portion between the frame connecting part, and the frame hinging part, can be appropriately widened to improve the connection strength.

The axle comprises a middle section extending in the horizontal direction and end sections extending upward in the vertical direction from two ends of the middle section, wherein the end sections are connected to the wheels, and a suspension device is arranged on each end section. The height of the middle section is the same as that of the frame, the height of a bottom plate of the through passage between the two vehicle bodies is the same as that of a floor of the vehicle body, and a bottom end of the through passage falls on the frame. The above axle and frame structure can adapt to low through passages and low-floor vehicle bodies. The first axle 42 and the second axle 44 have the same structure.

The first axle 42 and the second axle 44 are symmetrically provided with the traction devices, and the traction devices are connected to the two vehicle bodies respectively. The above bogie can be used as a trailer bogie, and the traction device is called trailer traction device below.

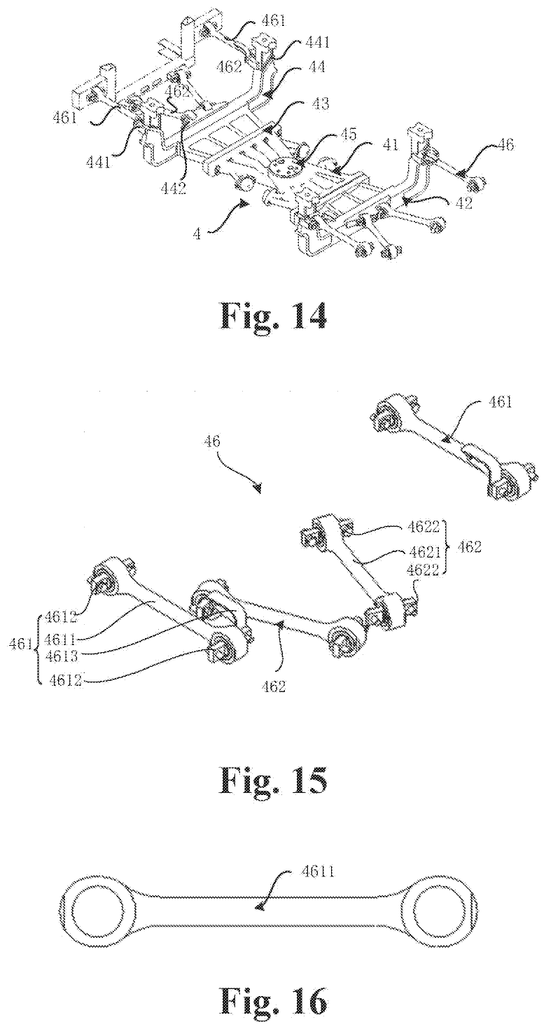

As shown in FIGS. 14 and 15, the embodiments provide a specific implementation. The trailer traction devices 46 are arranged on a side, backing onto the first frame 41, of the first axle 42 and a side, backing onto the second frame 43, of the second axle 44. The trailer traction device 46 of this embodiment comprises two first traction components 461 and two second traction components 462.

The end sections of the first axle 42 are respectively provided with outer axle traction rod bases 441, the middle section is provided with two inner axle traction rod bases 442, and the inner axle traction rod bases 442 are inclined toward the adjacent outer axle traction rod bases 441.

Correspondingly, the vehicle body is provided with two outer vehicle body traction rod bases 1153 and two inner vehicle body traction rod bases 1154. The inner vehicle body traction rod base 1154 is located between the two outer vehicle body traction rod bases 1153, and the inner vehicle body traction rod base 1154 is inclined away from the adjacent outer vehicle body traction rod bases 1153.

Two ends of the first traction component 461 are connected to the outer axle traction rod base 441 and the outer vehicle body traction rod base 1153 respectively. The two first traction components 461 are parallel to each other and extend longitudinally.

Two ends of the second traction component 462 are connected to the inner axle traction rod base 442 and the inner vehicle body traction rod base 1154 respectively. The two second traction components 462 are obliquely arranged, and first ends, connected to the axle, of the two second traction components 462 are located between second ends, connected to the vehicle body, of the two second traction components 462, so that the two second traction components 462 form a splay shape after being connected.

With the above arrangement, the two first traction components 461 and the two second traction components 462 jointly transmit the traction and braking force between the trailer bogie 4 and the vehicle body connected thereto, thus reducing the load on each traction component, and distributing the traction and braking force equally to the whole vehicle body framework and the trailer bogie 4, which avoids stress concentration. Moreover, the second traction component 462 can also transfer the lateral force between the vehicle body and the bogie, thus improving the stability of the vehicle during turning.

Meanwhile, this embodiment can keep the height of the two first traction components 461 consistent with the height of a wheel center, so as to reduce the loss of the traction and braking force during transmission, and also reduce the rate of wheel load reduction; and the two second traction components 462 can ensure the smooth transmission of the traction and braking force when the vehicle passes through a small curve, thus improving the transmission efficiency.

Optionally, an included angle between the second traction component 462 and the axle is 30°-40°, and an included angle between the second traction component 462 and an end face of the vehicle body is also 30°-40°. Within this range, the second traction component 462 can maintain a high transmission efficiency.

Optionally, the first traction component 461 of this embodiment comprises a first traction rod 4611 and two first traction rod nodes 4612. Two ends of the first traction rod 4611 are provided with first traction rod through holes respectively, the axial direction of the first traction rod through hole is perpendicular to the axial direction of the first traction rod 4611, and the first traction rod nodes 4612 are fixedly connected to the first traction rod through holes, that is, after one end of the first traction rod node 4612 passes through the first traction rod through hole, a middle part of the first traction rod node 4612 is fixed to the first traction rod through hole. The parts, located on two sides of the first traction rod through hole, of the first traction rod node 4612 are connected to the outer axle traction rod base 441 or the outer vehicle body traction rod base 1153 through bolt connection, hinge connection, etc.

The second traction component 462 comprises a second traction rod 4621 and two second traction rod nodes 4622. Two ends of the second traction rod 4621 are provided with second traction rod through holes respectively, and the axial direction of the second traction rod through hole is perpendicular to the axial direction of the second traction rod 4621. The second traction rod nodes 4622 are fixedly connected to the second traction rod through holes, that is, after one end of the second traction rod node 4622 passes through the second traction rod through hole, a middle part of the second traction rod node is connected to the second traction rod through hole. The parts, located on two sides of the second traction rod through hole, of the second traction rod node 4622 are connected to the inner axle traction rod base 442 or the inner vehicle body traction rod base 1154 through bolt connection, hinge connection, etc.

Preferably, the parts, located on two sides of the first traction rod through hole, of the first traction rod node 4612 are respectively provided with first connecting holes to be connected to the outer axle traction rod base 441 or the outer vehicle body traction rod base 1153. A first fastener passes through the first connecting hole and is fixed on the outer axle traction rod base 441 or the outer vehicle body traction rod base 1153. The first connecting hole may be a through hole, and the first fastener may be a bolt. Both the outer axle traction rod base 441 and the outer vehicle body traction rod base 1153 are provided with screw fixing holes which are matched with the first fasteners, and the first fastener can pass through the first connecting hole and be fixed in the screw fixing hole.

The parts, located on two sides of the second traction rod through hole, of the second traction rod node 4622 are respectively provided with second connecting holes to be connected to the inner axle traction rod base 442 or the inner vehicle body traction rod base 1154. A second fastener passes through the second connecting hole and is fixed on the inner axle traction rod base 442 or the inner vehicle body traction rod base 1154. The second connecting hole may be a through hole, and the second fastener may be a bolt. Both the inner axle traction rod base 442 and the inner vehicle body traction rod base 1154 are provided with screw fixing holes which are matched with the second fasteners, and the second fastener can pass through the first connecting hole and be fixed in the screw fixing hole.

In this implementation, bolt connection can facilitate the mounting and dismounting of the traction component, thus facilitating subsequent overhaul and maintenance.

Further, the first traction component 461 of this embodiment further comprises a height valve rod mounting base 4613, which is used for mounting a height valve rod to realize the adjustment function of an air spring within a limited space.

The height valve rod mounting base 4613 is located on a side, facing the first axle 42, of the first traction rod 4611, and the height valve rod mounting base 4613 is fixedly connected to a side, facing the second traction component 462, of the first traction rod node 4612.

Specifically, the height valve rod mounting base 4613 of this embodiment comprises a first flat plate and a second flat plate which are perpendicular to each other, the first flat plate is provided with a first fixing hole matched with the first connecting hole, and the second flat plate is used for mounting the height valve rod. The first flat plate and the second flat plate may be formed by bending the same steel plate, and a rib plate can be welded between them to increase connection strength.

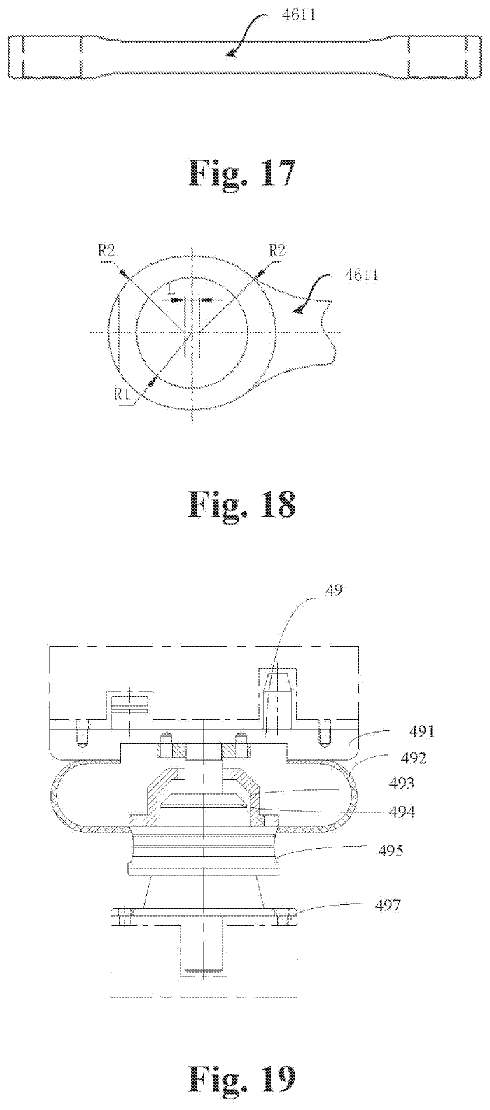

As shown in FIGS. 16, 17 and 18, the first traction rod through hole and the second traction rod through hole in this embodiment are both of an obround structure, so as to increase the strength of a joint between the traction rod node and the traction rod. Taking the first traction rod 4611 as an example, the radius of the first traction rod through hole is R1, and the above-mentioned oblong structure is that the end of the first traction rod 4611 covered with the first traction rod through hole is composed of two semicircular structures with a radius R2 and a horizontal part with a length L connected to the two semicircular structures, wherein the distance between the center of the semicircular structure and the center of the first traction rod through hole is L/2.

Further, in this embodiment, two ends of the first traction rod 4611 and the second traction rod 4621 are provided with chamfers to avoid interference with the vehicle body or trailer bogie 4 during operation.

Preferably, the first traction rod 4611 is a metal rod, the first traction rod node 4612 comprises a metal part and a rubber part, and the metal part and the rubber part are integrally vulcanized and molded. The second traction rod 4621 is a metal rod, the second traction rod node 4622 comprises a metal part and a rubber part, and the metal part and the rubber part are integrally vulcanized and molded.

The traction rods of this embodiment are forged and machined from alloy steel materials, and have high strength and good toughness. The traction rod nodes are made of metal and rubber through vulcanization, which can cushion the impact during traction and braking, adapt to the relative movement between the vehicle body and bogie, and optimize the stress state of the vehicle body and bogie.

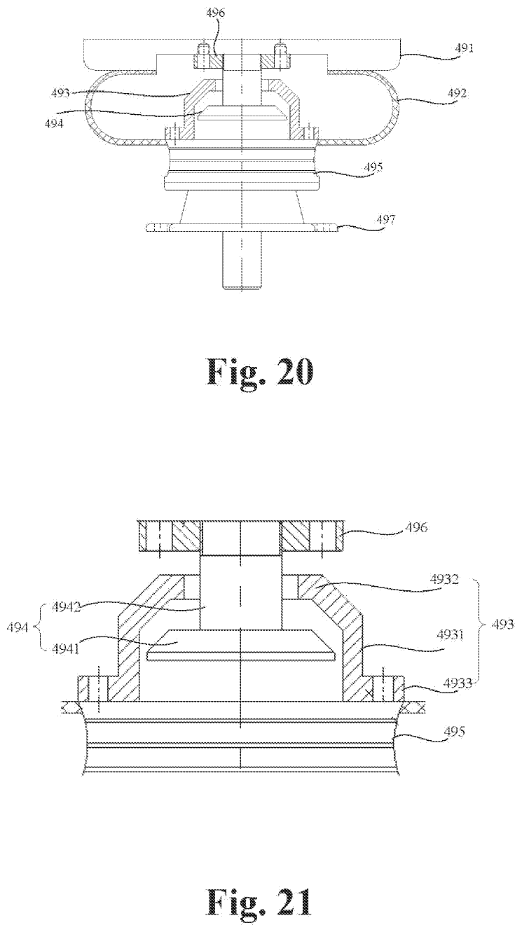

On the basis of the above technical scheme, the embodiments provide an implementation of the suspension device. As shown in FIGS. 19, 20 and 21, the suspension device is an air spring 49. The air spring 49 comprises an upper spring cover plate 491, an air bag 492, a flat rubber-metal pad 495 and a lifting component, wherein the upper spring cover plate 491, the air bag 492 and the flat rubber-metal pad 495 are arranged from top to bottom. The upper spring cover plate 491 is located at a top of the air spring 49, which is not only used for being fixedly connected to the vehicle body, but also can separate the air bag 492 from the vehicle body, thus reducing the risk of damage to the air bag 492 which may be caused when the air bag is directly connected to a bottom of the vehicle body.

A top of the air bag 492 is hermetically connected to the upper spring cover plate 491, a bottom of the air bag 492 surrounds a top of the flat rubber-metal pad 495, and the air bag 492 is hermetically connected to the flat rubber-metal pad 495, that is, the air bag 492, the upper spring cover plate 491 and the flat rubber-metal pad 495 form a sealed cavity, and air can be injected into or released from the air bag 492 to adjust the elasticity of the air spring 49.

The lifting component is arranged in the sealed cavity and can be used as a lifting device between the vehicle body and the framework. The lifting component comprises a limit stop cover 493 and a limit stopper 494. A bottom of the limit stop cover 493 is fixed on the flat rubber-metal pad 495 in a covering mode, and a gap is kept between a top of the limit stop cover 493 and the upper spring cover plate 491, so that the vehicle body can vibrate in the vertical direction during running. The limit stopper 494 comprises a limit stop block 4941 and a limit stop connecting rod 4942. A top of the limit stop cover 493 is provided with a through hole which is in clearance fit with the limit stop connecting rod 4942. One end of the limit stop connecting rod 4942 passes through the through hole to be connected to the upper spring cover plate 491, and the other end of the limit stop connecting rod 4942 extends into the limit stop cover 493 and is connected to the limit stop block 4941 located in the limit stop cover 493. If a force is applied to the limit stop connecting rod 4942 to lift it up or press it down, the limit stop block 4941 can move up and down in the limit stop cover 493.

The gap between the top of the limit stop cover 493 and the upper spring cover plate 491, and a gap between the top of the limit stop cover 493 and the limit stop block 4941 need to be larger than the maximum vertical displacement of the vehicle in normal operation, and a gap between the limit stop block 4941 and the flat rubber-metal pad 495 needs to be larger than the gap between the top of the limit stop cover 493 and the upper spring cover plate 491, so as to prevent the limit stop block 4941 from contacting the flat rubber-metal pad 495 when the air spring works normally.

When the limit stop connecting rod 4942 is subjected to an upward force, the limit stop block 4941 moves upward in the limit stop cover 493, and the limit stop block 4941 can abut against the top of the limit stop cover 493 to transmit the force to the limit stop cover 493 and then to the flat rubber-metal pad 495 through the limit stop cover 493, so that the framework under the vehicle body can be lifted together with the vehicle body.

According to the air spring 49 provided in this embodiment, the lifting component is arranged in the sealed cavity formed by the air bag 492, the upper spring cover plate 491 and the flat rubber-metal pad 495, which not only makes the air spring 49 have a vibration reduction function, but also connects the vehicle body with the flat rubber-metal pad 495 in the air spring 49 by the lifting component, and then connects the framework connected to the flat rubber-metal pad 495 with the vehicle body, thus allowing the lifting device to be arranged between the vehicle body and the framework, so that the framework under the vehicle body can be lifted together with the vehicle body.

On the basis of the above implementation, the air spring 49 further comprises a limit stop mounting plate 496, which may be a rectangular plate. The limit stop mounting plate 496 is fixed on a side, facing the limit stop cover 493, of the upper spring cover plate 491. The limit stop mounting plate 496 can be fixed on the upper spring cover plate 491 by a bolt, and a gap is reserved between the limit stop mounting plate 496 and the limit stop cover 493, so as to meet the need of the vehicle body for vertical vibration during running.

The limit stop mounting plate 496 can be used for fixing the limit stop connecting rod 4942. The limit stop mounting plate 496 is provided with a threaded hole, and an end, extending out of the limit stop cover 493, of the limit stop connecting rod 4942 is screwed into the threaded hole, thereby fixing the limit stop connecting rod 4942 to the limit stop mounting plate 496.

Further, the other end of the limit stop connecting rod 4942 extends into the limit stop cover 493, and an end, located in the limit stop cover 493, of the limit stop connecting rod 4942 is connected to the limit stop block 4941 located in the limit stop cover 493. The limit stop cover 493 comprises a stop cover body 4931, stop cover limit plates 4932 located at two ends of the stop cover body 4931 and a stop cover mounting edge 4933, wherein a bottom end of the stop cover body 4931 is provided with an opening, which is opposite to the flat rubber-metal pad 495, and an end face of the opening is attached to a surface of the flat rubber-metal pad 495, so that when the limit stop block 4941 vertically moves in the limit stop cover 493, the limit stop block 4941 can pass through the opening and abut against the flat rubber-metal pad 495 to limit the limit stop block 4941, thereby limiting the vertical downward displacement of the vehicle body and improving the driving safety of the vehicle.

The stop cover mounting edge 4933 is arranged along the circumferential direction of the bottom opening of the stop cover body 4931, and the stop cover mounting edge 4933 is located outside the stop cover body 4931. The stop cover mounting edge 4933 is used for fixing the stop cover body 4931 on the flat rubber-metal pad 495. For example, the stop cover mounting edge 4933 can be formed by folding the bottom end of the stop cover body 4931 outward. The stop cover mounting edge 4933 is provided with a bolt and is fixed on the flat rubber-metal pad 495 by the bolt, so that the flat rubber-metal pad 495 and the stop cover mounting edge 4933 are attached and fixed together.

A top end of the stop cover body 4931 is provided with the stop cover limit plate 4932, which can be seen as a bottom plate of the stop cover body 4931, that is, the stop cover body 4931 and the stop cover limit plate 4932 are integrated; or the top end of the stop cover body 4931 is provided with an opening, and a stop cover limit plate 4932 for blocking the opening is provided. In this embodiment, it is preferable to adopt an integral structure of the stop cover limit plate 4932 and the stop cover body 4931 to enhance the connection strength between the stop cover body 4931 and the stop cover limit plate 4932. The stop cover limit plate 4932 is provided with a through hole through which the limit stop connecting rod 4942 passes, the through hole can be located at a center of the stop cover limit plate 4932, and the through hole is in clearance fit with the limit stop connecting rod 4942, so that the limit stop connecting rod 4942 is inserted into the through hole and can slide vertically.

Further, the limit stop block 4941 is arranged in the stop cover body 4931, and the limit stop block 4941 is fixedly connected to one end of the limit stop connecting rod 4942. It can be understood that the limit stop block 4941 and the limit stop connecting rod 4942 can be of an integral structure to improve the connection strength between the limit stop connecting rod 4942 and the limit stop block 4941, thus preventing the limit stop connecting rod 4942 from separating from the limit stop block 4941 during lifting of the framework, which may affect the reliability of lifting.

In order to improve the reliability of lifting, a first inclined plane is arranged at a joint between the stop cover limit plate 4932 and the stop cover body 4931, and the first inclined plane is located on an inner side of the limit stop cover 493, that is, the first inclined plane can be regarded as part of an inner surface of the limit stop cover 493. A side, facing the stop cover limit plate 4932, of the limit stop block 4941 is provided with a second inclined plane, and the second inclined plane is matched with the first inclined plane. When the limit stop block 4941 is lifted up and abuts against the stop cover limit plate 4932, the first inclined plane and the second inclined plane are attached. By applying a force between the first inclined plane and the second inclined plane, the first inclined plane and the second inclined plane can be better attached, so as to improve the stability of the limit stop block 4941 and the limit stop cover 493 in the lifting process.

On the basis of the above implementation, in order to facilitate the installation of the air spring 49 to the framework, the air spring 49 provided in this embodiment further comprises a lower spring cover plate 497, which is located on a side, away from the air bag 492, of the flat rubber-metal pad 495, and can be fixed on the framework by a bolt, so as to install the air spring 49 on the framework. It can be understood that the air spring 49 comprises a upper spring cover plate 491, an air bag 492, a flat rubber-metal pad 495 and a lower spring cover plate 497 which are arranged in sequence. The upper spring cover plate 491, the air bag 492, the flat rubber-metal pad 495 and the lower spring cover plate 497 form an integral structure, which can enhance the structural strength of the air spring 49 and the tightness of the air bag 492, and also improves the installation efficiency of the air spring 49.

Further, the lower spring cover plate 497 is provided with a positioning pin, which is located on a side, away from the flat rubber-metal pad 495, of the lower spring cover plate 497, and the positioning pin and the lower spring cover plate 497 can form an integral structure to enhance the connection strength between the lower spring cover plate 497 and the positioning pin. The framework is provided with an insertion hole matched with the positioning pin. After the positioning pin is inserted into the insertion hole of the framework, the lower spring cover plate 497 and an upper surface of the framework can be attached and fastened together by a bolt. With this arrangement, the positioning accuracy between the air spring 49 and the framework can be improved, and an acting force of the air spring 49 can vertically act on the framework, so as to achieve the damping effect of the air spring 49.

On the basis of the above technical scheme, the bogie also comprises steering driving devices. The steering driving devices are connected to the wheels and used for driving the wheels to steer relative to the corresponding axles. The number of the steering devices is two, which are respectively connected to the wheels on the two axles and used for driving the corresponding wheels to steer, and the two wheels on the same axle steer synchronously.

The steering driving device comprises a steering driving part and a steering transmission part. The steering transmission part is connected between the wheel and the steering driving part, and is used for transmitting the steering power provided by the steering driving part to the wheel.

The transmission part comprises a power steering swing arm, a longitudinal drawbar, a wheel steering swing arm and a lateral drawbar. A first end of the power steering swing arm is connected to an output end of the steering driving part, and the power steering swing arm can rotate around the first end in the vertical plane. The longitudinal drawbar extends in the direction perpendicular to the axle, and a first end of the longitudinal drawbar is hinged to a second end of the power steering swing arm. The wheel steering swing arm is fixedly connected to the wheel, and has a first sub-swing arm and a second sub-swing arm, and the first sub-swing arm is hinged to a second end of the longitudinal drawbar. The lateral drawbar extends in a direction parallel to the axle, and two ends of the lateral drawbar are respectively hinged to the second sub-swing arms of the wheel steering swing arm corresponding to the two wheels.

When the bogie is trailer bogie, the wheel steering swing arm is called trailer steering swing arm, the first sub-swing arm is called first trailer sub-swing arm, and the second sub-swing arm is called the second trailer sub-swing arm.

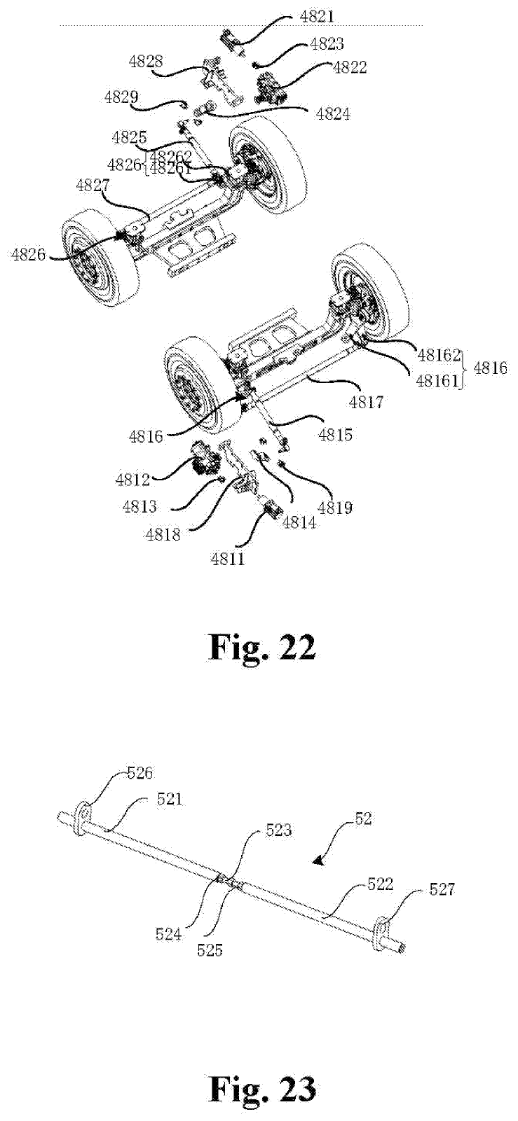

As shown in FIGS. 4 and 22, the steering driving device comprises a first steering driving device 481 connected to the first frame 41 and a second steering driving device 482 connected to the second frame 43. The first steering driving device 481 is connected to the first trailer wheel 4201 to drive the first trailer wheel 4201 to steer. The second steering driving device 482 is connected to the second trailer wheel 4401 to drive the second trailer wheel 4401 to steer.

The first frame 41 and the second frame 43 of the bogie provided by the embodiments are hinged together, the rotation of the first trailer wheel 4201 is controlled by the first steering driving device 481, and the rotation of the second trailer wheel 4401 is controlled by the second steering driving device 482, so that the steering of the first vehicle body connected to the first frame 41 and the second vehicle body connected to the second frame 43 can be separately controlled, which is conducive to reducing the turning radius of the vehicle, facilitates driving, and improves driving flexibility on urban roads.

Specifically, the first steering driving device 481 of this embodiment comprises a first driving part and a first transmission part, and the first driving part is used for providing steering power, and the first transmission part is connected to the first driving part and the first trailer wheel 4201, and the first transmission part is used for transmitting the steering power provided by the first driving part to the first trailer wheel 4201.

The second steering driving device 482 comprises a second driving part and a second transmission part, and the second driving part is used for providing steering power, and the second transmission part is connected to the second driving part and the second trailer wheel 4401, and the second transmission part is used for transmitting the steering power provided by the second driving part to the second trailer wheel 4401.

The first driving part comprises a first servo motor 4811 and a first power steering gear 4812. The first servo motor 4811 communicates with the controller to realize automatic steering, and the first servo motor 4811 is used for outputting the steering force. The first power steering gear 4812 is used for changing the direction of the steering force output by the first servo motor 4811 to provide steering power for the first transmission part. The first power steering gear 4812 is connected to an output end of the first servo motor 4811 through a first coupling 4813, and an output end of the first power steering gear 4812 is connected to the first transmission part.

The second driving part comprises a second servo motor 4821 and a second power steering gear 4822, the second servo motor 4821 communicates with the controller to realize automatic steering, and the second servo motor 4821 is used for outputting the steering force. The second power steering gear 4822 is used for changing the direction of the steering force output by the second servo motor 4821 to provide steering power for the second transmission part. The second power steering gear 4822 is connected to an output end of the second servo motor 4821 through a second coupling 4823, and an output end of the second power steering gear 4822 is connected to the second transmission part.

In a possible implementation, the first transmission part of this embodiment comprises a first power steering swing arm 4814, a first longitudinal drawbar 4815, a first trailer steering swing arm 4816 and a first lateral drawbar 4817. A first end of the first power steering swing arm 4814 is connected to the output end of the first power steering gear 4812. A first end of the first longitudinal drawbar 4815 is connected to a second end of the first power steering swing arm 4814. The first trailer steering swing arm 4816 is fixedly connected to the first trailer wheel 4201, and comprises a first body, and a first trailer sub-swing arm 48161 and a second trailer sub-swing arm 48162 which are connected to the first body. The first body is fixedly connected to the first trailer wheel 4201, both the first trailer sub-swing arm 48161 and the second trailer sub-swing arm 48162 are connected to the first body, and an included angle is formed between the first trailer sub-swing arm 48161 and the second trailer sub-swing arm 48162. A second end of the first longitudinal drawbar 4815 is connected to the first trailer sub-swing arm 48161. Two ends of the first lateral drawbar 4817 are respectively connected to the second trailer sub-swing arms 48162 on the two first trailer steering swing arms 4816.

The second transmission part of this embodiment comprises a second power steering swing arm 4824, a second longitudinal drawbar 4825, a second trailer steering swing arm 4826 and a second lateral drawbar 4827, and a first end of the second power steering swing arm 4824 is connected to the output end of the second power steering gear 4822. A first end of the second longitudinal drawbar 4825 is connected to a second end of the second power steering swing arm 4824. The second trailer steering swing arm 4826 is fixedly connected to the second trailer wheel 4401, and comprises a second body, and a third trailer sub-swing arm 48261 and a fourth trailer sub-swing arm 48262 which are connected to the second body. The second body is fixedly connected to the second trailer wheel 4401, the third trailer sub-swing arm 48261 and the fourth trailer sub-swing arm 48262 are both connected to the second body, and an included angle is formed between the third trailer sub-swing arm 48261 and the fourth trailer sub-swing arm 48262. A second end of the second longitudinal drawbar 4825 is connected to the third trailer sub-swing arm 48261. Two ends of the second lateral drawbar 4827 are respectively connected to the fourth trailer sub-swing arms 48262 on the two second trailer steering swing arms 4826.

In this embodiment, by adjusting the lengths of the first longitudinal drawbar 4815 and the first lateral drawbar 4817 and the included angle between the first trailer sub-swing arm 48161 and the second trailer sub-swing arm 48162, the requirement for different extreme deflection angles of the first trailer wheel 4201 when passing through a curve can be met. Similarly, by adjusting the lengths of the second longitudinal drawbar 4825 and the second lateral drawbar 4827 and the included angle between the third trailer sub-swing arm 48261 and the fourth trailer sub-swing arm 48262, the requirement for different deflection angles of the second trailer wheel 4401 when passing through a curve can be met.

When the steering driving device of this embodiment is in use, the first servo motor 4811 receives a steering input signal transmitted by the controller and then outputs steering torque. The steering torque output by the first servo motor 4811 is transmitted to a first power transmitter through the first coupling 4813, and the first power transmitter outputs rotational torque to drive the first power steering swing arm 4814 to swing. The first power steering swing arm 4814 transmits the rotational torque to the first trailer steering swing arm 4816 through the first longitudinal drawbar 4815. Because the first trailer steering swing arm 4816 is fixedly connected to the first trailer wheel 4201, and the two first trailer steering swing arms 4816 are connected through the first lateral drawbar 4817, the two first trailer wheels 4201 can be driven to synchronously move and deflect.

Similarly, the second servo motor 4821 receives a steering input signal transmitted by the controller and then outputs steering torque. The steering torque output by the second servo motor 4821 is transmitted to a second power transmitter through the second coupling 4823, and the second power transmitter outputs rotational torque to drive the second power steering swing arm 4824 to swing. The second power steering swing arm 4824 transmits the rotational torque to the second trailer steering swing arm 4826 through the second longitudinal drawbar 4825. Because the second trailer steering swing arm 4826 is fixedly connected to the second trailer wheel 4401, and the two second trailer steering swing arms 4826 are connected by the second lateral drawbar 4827, the two second trailer wheels 4401 can be driven to synchronously move and deflect.

In addition, this embodiment also comprises a first mounting base 4818, which is connected to the first vehicle body. The first servo motor 4811 and the first power steering gear 4812 are both arranged on the first mounting base 4818. The first mounting base 4818 is provided with a first limit switch 4819, and the first limit switch 4819 is arranged on a side, facing the first longitudinal drawbar 4815, of the first mounting base 4818. When the first longitudinal drawbar 4815 contacts the first limit switch 4819, the first limit switch 4819 generates a signal and feeds it back to the controller, and the controller will issue an instruction to stop the first power transmitter from moving in this direction.

This embodiment also comprises a second mounting base 4828, which is connected the second vehicle body. The second servo motor 4821 and the second power steering gear 4822 are both arranged on the second mounting base 4828. The second mounting base 4828 is provided with a second limit switch 4829, and the second limit switch 4829 is arranged on a side, facing the second longitudinal drawbar 4825, of the second mounting base 4828. When the second longitudinal drawbar 4825 contacts the second limit switch 4829, the second limit switch 4829 generates a signal and feeds it back to the controller, and the controller will issue an instruction to stop the second power transmitter from moving in this direction.

On the basis of the above technical scheme, chucking fixing holes are respectively formed in the two frames, and the chucking fixing holes in the two frames are used for the insertion of two ends of a chucking tool so as to fix the relative positions of the two frames. The length of the chucking tool is fixed.

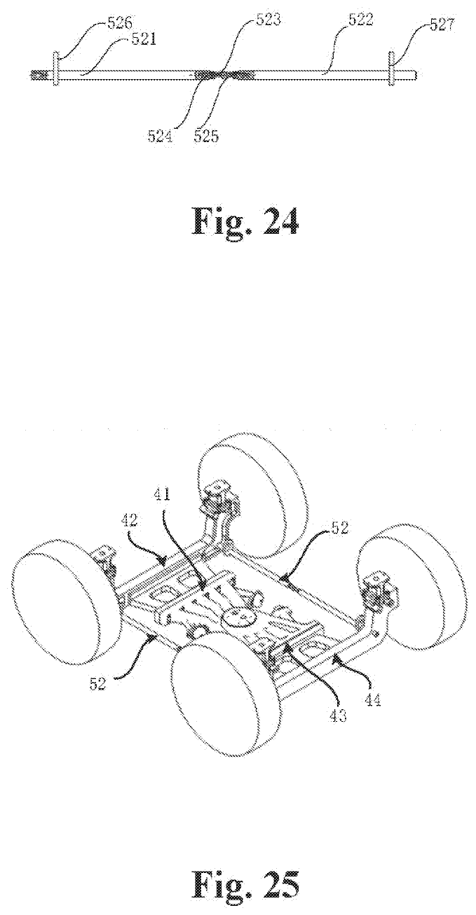

Specifically, as shown in FIGS. 23 and 24, the embodiments provide a chucking device for fixing the bogie to prevent the bogie from rotating during transportation and lifting. The first frame 41 is provided with a first chucking fixing hole, and the second frame 43 is provided with a second chucking fixing hole. When in use, two ends of the chucking device 52 are inserted into the first chucking fixing hole and the second chucking fixing hole respectively to lock and fix the first frame 41 and the second frame 43, so as to prevent relative rotation.

In an alternative implementation, the chucking device 51 comprises a first fixing rod 511, a second fixing rod 512 and a connecting rod 513, wherein a first end of the first fixing rod 511 is inserted into the first chucking fixing hole, that is, the first end of the first fixing rod 511 can be inserted from one side of the first chucking fixing hole and extend from the other side of the first chucking fixing hole, and a first fixing part is relatively fixed to the first frame 41 after being matched with a first fastener. That is, in this embodiment, the first fixing rod 511 and the first frame 41 can be relatively fixed by the first fixing part.

A first end of the second fixing rod 512 is inserted into the second chucking fixing hole, that is, the first end of the second fixing rod 512 can be inserted from one side of the second chucking fixing hole and extend from the other side of the second chucking fixing hole, and a second fixing part is relatively fixed to the second frame 43 after being matched with a second fastener. That is, in this embodiment, the second fixing rod 512 and the second frame 43 can be relatively fixed by the second fixing part.

Two ends of the connecting rod 513 are connected to a second end of the first fixing rod 511 and a second end of the second fixing rod 512, respectively. That is, in this embodiment, the first fixing rod 511 and the second fixing rod 512 can be connected into a whole by the connecting rod 513, and since the first frame 41 and the first fixing rod 511 can be relatively fixed and the second frame 43 and the second fixing rod 512 can be relatively fixed, the first frame 41 and the second frame 43 can stay relatively fixed through the connection by the connecting rod 513.

As can be seen from the above description, the chucking device 51 of this embodiment can be matched with a fixing hole in the trailer bogie, so as to relatively fix an articulated part of the trailer bogie, thus achieving the purposes of preventing the trailer bogie from rotating and protecting the trailer bogie during transportation and assembly.

In one implementation, a surface of the first fixing part may be provided with external threads, and the first fastener may be a nut with internal threads, and the nut abuts against a surface of the first frame 41 through the matching of the threads and the nut, so that the first fixing rod 511 and the first frame 41 are relatively fixed.

Similarly, a surface of the second fixing part may be provided with external threads, and the second fastener may be a nut with internal threads. The nut abuts against a surface of the second frame 43 through the matching of the threads and the nut, so that the second fixing rod 512 and the second frame 43 are relatively fixed.

In another implementation, the first fixing part may be provided with a first through hole, an axis of which is perpendicular to an axis of the first fixing rod 511, and the first fastener is a shaft pin which can extend into the first through hole. After the first fixing part passes through the first chucking fixing hole, the shaft pin can be inserted into the first through hole, so that the first fixing part can abut against the surface of the first frame 41 by means of the shaft pin, thus allowing the first fixing rod 511 and the first frame 41 to be relatively fixed.

Similarly, the second fixing part may be provided with a second through hole, an axis of which is perpendicular to an axis of the second fixing rod 512, and the second fastener is a shaft pin which can extend into the second through hole. After the second fixing part passes through the second chucking fixing hole, the shaft pin can be inserted into the second through hole, so that the second fixing part can abut against the surface of the second frame 43 by means of the shaft pin, thus allowing the second fixing rod 512 and the second frame 43 to be relatively fixed.

In another implementation, the first fixing part may be an elastic part, and the elastic part comprises a plurality of chucking jaws arranged at an end, backing onto the first fixing rod 511, of the first fixing part, and the chucking jaws are distributed in the same circumferential surface at equal intervals. When the first fixing part is in a compressed state, the outer diameter of the chucking jaw is smaller than the inner diameter of the first chucking fixing hole, so that the first fixing part passes through the first chucking fixing hole. When the first fixing part is in a natural state, the outer diameter of the chucking jaw is larger than the inner diameter of the first chucking fixing hole, and the chucking jaw abuts against the surface of the first frame 41 so that the first fixing part and the first frame 41 are relatively fixed.

Similarly, the second fixing part is an elastic part, a plurality of chucking jaws are arranged on a side, backing onto the second end of the second fixing rod 512, of the second fixing part, and the chucking jaws are distributed in the same circumferential surface at equal intervals. When the second fixing part is in a compressed state, the outer diameter of the chucking jaw is smaller than the inner diameter of the second chucking fixing hole, so that the second fixing part passes through the second chucking fixing hole. When the second fixing part is in a natural state, the outer diameter of the chucking jaw is larger than the inner diameter of the second chucking fixing hole, and the chucking jaw abuts against the surface of the second frame 43 so that the second fixing part and the second frame 43 are relatively fixed.

It can be seen from the above three implementations that assembly and disassembly between the chucking device 51 provided in this embodiment and a body of the trailer bogie can be realized quickly, which facilitates use and improves work efficiency.

It should be noted that only three possible implementations are given above, and it is clear to those skilled in the art that other possible fixing methods can be adopted to fix the fixing rods and the corresponding frames, which is not limited in this embodiment.

In this embodiment, the first fixing rod 511 is further provided with a first boss 514, which is arranged close to the first fixing part, the diameter of the first boss 514 is larger than the inner diameter of the first chucking fixing hole, the first boss 514 abuts against one side of the first chucking fixing hole, and the first fixing part abuts against the other side of the first chucking fixing hole, so that connection stability can be improved.

Similarly, the second fixing rod 512 is further provided with a second boss 515, which is arranged close to the second fixing part, the diameter of the second boss 515 is larger than the inner diameter of the second chucking fixing hole, the second boss 515 abuts against one side of the second chucking fixing hole, and the second fixing part abuts against the other side of the second chucking fixing hole, so that connection stability can be improved.

Further, in order to improve the strength of the chucking device 51, this embodiment further comprises a first reinforcing rod 516 and a plurality of second reinforcing rods 517. Two ends of the first reinforcing rod 516 are connected to the first fixing rod 511 and the second fixing rod 512, respectively. The first reinforcing rod 516 is near the second end of the first fixing rod 511 and the second end of the second fixing rod 512. By arranging the first reinforcing rod 516, the strength of the chucking device 51 in an axial direction of the connecting rod 513 can be improved. Two ends of the second reinforcing rod 517 are connected to the first reinforcing rod 516 and the connecting rod 513, respectively. By arranging the second reinforcing rod 517, the strength of the chucking device 51 in an axial direction of the first fixing rod 511 can be improved. The first reinforcing rod 516 may be parallel to the connecting rod 513, so that the lengths of the second reinforcing rods 517 are equal, which is conducive to installation and manufacture.

In addition, the first fixing rod 511, the second fixing rod 512 and the connecting rod 513 of this embodiment may also be made in an integrated manner, thereby further improving the overall strength of the chucking device 51.

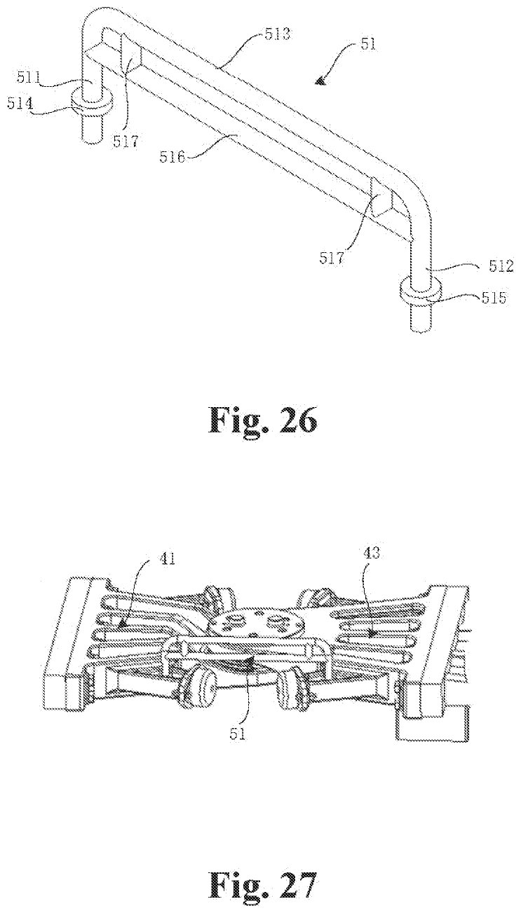

As shown in FIGS. 25, 26 and 27, this embodiment provides another chucking device. The first chucking fixing hole and the second chucking fixing hole can be respectively arranged on the first axle 42 and the second axle 44, and the chucking device 52 comprises a first fixing rod 521 and a second fixing rod 522.

The first end of the first fixing rod 521 is used for being inserted into the first chucking fixing hole. Optionally, the first chucking fixing hole may be a threaded hole. The first end of the first fixing rod 521 may be provided with external threads, and the first end of the first fixing rod 521 is directly screwed into the first chucking fixing hole to lock and fix the first fixing rod 521 and the first axle 42.

The first end of the second fixing rod 522 is used for being inserted into the second chucking fixing hole. Optionally, the second chucking fixing hole may be a threaded hole. The first end of the second fixing rod 522 may be provided with external threads, and the first end of the second fixing rod 522 is directly screwed into the second chucking fixing hole to lock and fix the second fixing rod 522 and the second axle 44.

The second end of the first fixing rod 521 and the second end of the second fixing rod 522 are connected by a telescopic mechanism, which is used to adjust the length of the chucking device 52. That is, in this embodiment, the distance between the first fixing rod 521 and the second fixing rod 522 can be adjusted by the telescopic mechanism, so that the chucking device 52 can adapt to trailer bogies of various sizes, and the mounting and dismounting of the chucking device 52 are facilitated. Before mounting, the whole chucking device 52 can be reduced in size by shortening the distance between the first fixing rod 521 and the second fixing rod 522, so as to be mounted on the trailer bogic more easily. During mounting, after one end of the chucking device 52 is fixed, the telescopic mechanism can be adjusted to extend the chucking device 52, so that two ends of the chucking device 52 are respectively fixed to the first axle 42 and the second axle 44, allowing the trailer bogie to be fixed through chucking.

As can be seen from the above description, the chucking device 52 of this embodiment can be matched with a fixing hole in the bogie, so as to relatively fix an articulated part of the trailer bogie, thus achieving the purposes of preventing the trailer bogie from rotating and protecting the trailer bogie during transportation and assembly.

In a possible implementation, the telescopic mechanism comprises a fixing shaft 523, an outer surface of which is provided with external threads, wherein external threads of a first end of the fixing shaft 523 and external threads of a second end of the fixing shaft 523 have opposite thread rotation directions. The second end of the first fixing rod 521 is provided with a first shaft hole with internal threads, the second end of the second fixing rod 522 is provided with a second shaft hole with internal threads, the first end of the fixing shaft 523 is in threaded connection with the first shaft hole, and the second end of the fixing shaft 523 is in threaded connection with the second shaft hole.

The telescopic mechanism also comprises a first looking member, which comprises a first looking nut 524 and a second locking nut 525. The first end of the fixing shaft 523 is sleeved with the first locking nut 524, and the second end of the fixing shaft 523 is sleeved with the second locking nut 525.

When the chucking device 52 of this embodiment is used, components of the chucking device 52 are connected in turn first, and the fixing shaft 523 is adjusted to make the overall length of the chucking device 52 within a proper range, so that the chucking device 52 can be easily placed between the first axle and the second axle without leaving too much clearance. Then, the first fixing rod 521 is inserted into the first chucking fixing hole and fixed to the first axle, and the fixing shaft 523 is adjusted to insert the second fixing rod 522 into the second chucking fixing hole. Finally, the fixing shaft 523 is adjusted to make the lengths of the chucking devices 52 on both sides identical, and the first locking nut 524 and the second looking nut 525 are tightened to complete the installation.

During dismounting, the first locking nut 524 and the second looking nut 525 are loosened first, then the second fixing rod 522 is dismounted from the second axle, the fixing shaft 523 is adjusted so that the chucking device 52 can be taken out, and finally the first fixing rod 521 is dismounted from the first axle to remove the whole chucking device 52.

In another implementation, the telescopic mechanism comprises a sleeve and a screw rod, an inner wall of the sleeve is provided with internal threads matched with the screw rod, and the screw rod is screwed in the sleeve, so that the length of the telescopic mechanism can be adjusted by rotating the sleeve.

Optionally, the sleeve can be fixed to the second end of the first fixing rod 521 or the second end of the second fixing rod 522. Correspondingly, the screw rod can be fixed to the second end of the second fixing rod 522 or the second end of the first fixing rod 521.

Further, this implementation also comprises a second locking member, which is used to lock or unlock the sleeve and the screw rod. Optionally, the sleeve can be provided with a first through hole, the screw rod can be provided with a plurality of first chucking fixing holes in an axial direction, and the second locking member can be fixed in the first chucking fixing holes after passing through the first through hole, so that the sleeve and the screw rod can be relatively locked. In this embodiment, the second locking member may be a bolt, and the first chucking fixing hole may be a threaded hole.

In another implementation, the telescopic mechanism comprises a fixed sleeve and a sliding sleeve, and the sliding sleeve can be sleeved outside the fixed sleeve and move along the fixed sleeve, so that the length of the telescopic mechanism can be adjusted by sliding the sliding sleeve.

Optionally, the fixed sleeve is fixed to the second end of the first fixing rod 521 or the second end of the second fixing rod 522. Correspondingly, the sliding sleeve is fixed to the second end of the second fixing rod 522 or the second end of the first fixing rod 521.

Further, this implementation also comprises a third locking member, and the second locking member is used to lock or unlock the fixed sleeve and the sliding sleeve. Optionally, the sliding sleeve is provided with a second through hole, the fixed sleeve is axially provided with a plurality of second chucking fixing holes, and the third locking member can be fixed in the second chucking fixing holes after passing through the second through hole, so that the fixed sleeve and the sliding sleeve are relatively looked. In this embodiment, the third looking member may be a bolt, and the second chucking fixing hole may be a threaded hole.

Further, in this embodiment, the first end of the first fixing rod 521 is further provided with a first lifting plate 526, and the first lifting plate 526 is provided with a first lifting hole. The first end of the second fixing rod 522 is further provided with a second lifting plate 527, and the second lifting plate 527 is provided with a second lifting hole. The first lifting plate 526 is fixedly connected to the first fixing rod 521, and the second lifting plate 527 is fixedly connected to the second fixing rod 522. Both the first lifting plate 526 and the second lifting plate 527 have a certain thickness to meet the requirement for lifting strength.

Although the preferred embodiments of the application have been described, those skilled in the art can make additional changes and modifications to these embodiments once they know the basic inventive concepts. Therefore, the appended claims are intended to be interpreted as including the preferred embodiment and all changes and modifications that fall within the scope of the application.

Obviously, those skilled in the art can make various changes and modifications to the application without departing from the spirit and scope of the application. Thus, if these modifications and variations of the application fall within the scope of the claims of the application and their equivalents, the application is also intended to comprise these modifications and variations.

1. A control method of a rubber-tired train, wherein the rubber-tired train comprises multiple cars connected in series in turn, the cars include a relatively front car and a relatively rear car, and the front car is able to rotate in a horizontal plane relative to the rear car; and
the method comprises the following steps:
acquiring a turning angle of the front car at a target position;
determining a turning angle of the rear car at the target position according to the turning angle of the front car; and
when it is determined that the rear car reaches the target position, controlling the rear car to steer according to the determined turning angle of the rear car.

2. The method according to claim 1, wherein,
a front of a bottom of the car is provided with a first wheelset, and a rear of the bottom of the car is provided with a second wheelset; and
controlling the car to steer comprises:
controlling the first wheelset to steer when the first wheelset at the bottom of the car reaches the target position; and
controlling the second wheelset to steer when the second wheelset at the bottom of the car reaches the target position.

3. The method according to claim 2, wherein,
controlling the first wheelset to steer when the first wheelset at the bottom of the car reaches the target position comprises:
acquiring position information of the car; and
controlling the first wheelset to steer when it is determined that the first wheelset at the bottom of the car reaches the target position according to the position information of the car.

4. The method according to claim 2, wherein,
controlling the second wheelset to steer when the second wheelset at the bottom of the car reaches the target position comprises:
acquiring position information of the car; and
controlling the second wheelset to steer when it is determined that the second wheelset at the bottom of the car reaches the target position according to the position information of the car.

5. The method according to claim 2, wherein,
a locomotive at a front end of the rubber-tired train is taken as the front car; and
controlling the first wheelset to steer when the first wheelset at the bottom of the car reaches the target position comprises:
acquiring mileage of the locomotive; and
controlling the first wheelset of the rear car to steer when it is determined that the first wheelset of the rear car reaches the target position according to the mileage of the locomotive and a distance between the first wheelset of the rear car and the first wheelset at the bottom of the locomotive.

6. The method according to claim 2, wherein,
a locomotive at a front end of the rubber-tired train is taken as the front car; and
controlling the second wheelset to steer when the second wheelset at the bottom of the car reaches the target comprises:
acquiring mileage of the locomotive; and
controlling the second wheelset at the bottom of the locomotive to steer when it is determined that the second wheelset at the bottom of the locomotive reaches the target position according to the mileage of the locomotive and a distance between the second wheelset at the bottom of the locomotive and the first wheelset at the bottom of the locomotive, or
controlling the second wheelset of the rear car to steer when it is determined that the second wheelset of the rear car reaches the target position according to the mileage of the locomotive and a distance between the second wheelset of the rear car and the first wheelset at the bottom of the locomotive.

7. The method according to claim 5, wherein,
acquiring mileage of the locomotive comprises:
acquiring the number of magnetic nails arranged on a ground detected by a magnetic sensor and a current vehicle speed detected by a speed sensor; and
determining the mileage of the locomotive according to the number of the magnetic nails and the current vehicle speed.

8. The method according to claim 7, wherein,
determining the mileage of the locomotive according to the number of the magnetic nails and the current vehicle speed comprises:
determining the mileage of the front car according to the following formula:
S=M×D+(t₂−t₁)×V;
where S is the mileage of the front car, M is the number of the magnetic nails, D is a preset distance between adjacent magnetic nails, V is a current vehicle speed, t₂ is a current time when the speed sensor sends signals, and t₁ is a current time when the magnetic sensor sends signals.

9. The method according to claim 1, wherein,
a locomotive at a front end of the rubber-tired train is taken as the front car; and
acquiring a turning angle of the front car at a target position comprises:
acquiring a route deviation between a current route of the locomotive and a target running route; and
determining a turning angle of a first wheelset of the front car at the target position according to the route deviation.

10. The method according to claim 1, wherein,
a locomotive at a front end of the rubber-tired train is taken as the front car; and
acquiring a turning angle of the front car at a target position comprises:
receiving an input steering control instruction, and determining a turning angle of a first wheelset of the locomotive according to the steering control instruction.

11. The method according to claim 1, wherein,
a locomotive at a front end of the rubber-tired train is taken as the front car; and
determining a turning angle of the rear car according to the turning angle of the front car comprises:
determining a turning angle of each wheelset of each rear car according to a turning angle of a first wheelset of the locomotive; and
the method further comprises:
determining a turning angle of a second wheelset at a bottom of the locomotive according to the turning angle of the first wheelset of the locomotive.

12. A control system of a rubber-tired train, wherein the rubber-tired train comprises multiple cars connected in series in turn, the cars include a relatively front car and a relatively rear car, and the front car is able to rotate in a horizontal plane relative to the rear car; and
the control system comprises:
a processing module used for acquiring a turning angle of the front car at a target position and determining a turning angle of the ear car at the target position according to the turning angle of the front car; and
a control module used for controlling the rear car to steer according to the determined turning angle of the rear car when it is determined that the rear car reaches the target position.

13. A rubber-tired train, comprising:
multiple cars connected in series in turn and the control system according to claim 12, wherein the can include a relatively front car and a relatively rear car, and the front car is hinged to the rear car through a trailer bogie, so that the front car is able to rotate relative to the rear car.

14. The rubber-tired train according to claim 13, wherein the trailer bogic comprises:
two axles, two ends of each said axle being respectively provided with wheels which am able to rotate relative to the axle;
two frames extending in a direction perpendicular to the axles and located between the two axles, each having an end connected to the adjacent axle, as well as an end hinged to the other frame, and being able to rotate relatively in the horizontal plane;
suspension devices symmetrically arranged on the axles, a top of the suspension device being connected to a vehicle body; and
a traction device having an end connected to the axle, as well as an end connected to the vehicle body.

15. The rubber-tired train according to claim 14, wherein,
the frame comprises a frame connecting part and a frame hinging part, the frame connecting part is connected between the axle and the frame hinging part, frame buffer devices are symmetrically arranged on two sides of the frame hinging part in a horizontal direction, and an end, away from the frame connecting part, of the frame hinging part is connected to a first rotator or a second rotator.

16. The rubber-tired train according to claim 15, wherein,
a width of an end, connected to the frame connecting part, of the frame hinging part is greater than that of the end connected to the other frame, and a width of the frame hinging part gradually decreases in the direction from the axle to a frame hinging position; and the first frame hinging part is provided with a plurality of vertical through holes, and a side wall, facing the frame connecting part, of the through hole is provided with a bolt hole of which a center line extends in the horizontal direction, so as to be connected to the frame connecting part by a bolt passing through the bolt hole.

17. The rubber-tired train according to claim 14, wherein,
the trailer bogie comprises a frame buffer device which is arranged on at least one said frame to serve as a buffer when the two frames are in rotary contact.

18. The method according to claim 6, wherein,
acquiring mileage of the locomotive comprises:
acquiring the number of magnetic nails arranged on a ground detected by a magnetic sensor and a current vehicle speed detected by a speed sensor; and
determining the mileage of the locomotive according to the number of the magnetic nails and the current vehicle speed.

19. The method according to claim 18, wherein,
determining the mileage of the locomotive according to the number of the magnetic nails and the current vehicle speed comprises:
determining the mileage of the front car according to the following formula:
S=M×D+(t₂−t₁)×V;
where S is the mileage of the front car, M is the number of the magnetic nails, D is a preset distance between adjacent magnetic nails, V is a current vehicle speed, t₂ is a current time when the speed sensor sends signals, and t₁ is a current time when the magnetic sensor sends signals.
